(19) United States
(12) Patent Application Publication
(10) Pub. No.: US 2017/0091865 A1
(43) Pub. Date: Mar. 30, 2017

(54) Universal Methodology for Gathering, Organizing and Analyzing an Individual's Relevant Financial Information

(71) Applicant: Robert M. Hayden, New York, NY (US)

(72) Inventor: Robert M. Hayden, New York, NY (US)

(21) Appl. No.: 15/276,399

(22) Filed: Sep. 26, 2016

Related U.S. Application Data
(60) Provisional application No. 62/234,597, filed on Sep. 29, 2015.
(60) Provisional application No. 62/233,308, filed on Sep. 26, 2015.

(51) Int. Cl. G06Q 40/06; G06Q 40/08

(52) U.S. Cl. CPC G06Q 40/06; G06Q 40/08

(57) ABSTRACT

A method for gathering, organizing, and analyzing an individual's financial information includes using a computer to gather financial information from an individual. A balance sheet is automatically generated with the computer using the gathered financial information, the balance sheet having an asset column and a liability column. A cash flow projections report is automatically generated with the computer using the gathered financial information, the cash flow projections report having year-by-year projections until a year of expected death for the individual. A financial score of 0 to 100 is calculated with the computer using the gathered financial information, the balance sheet, and the cash flow projections report.

### CROSS-REFERENCE TO RELATED APPLICATIONS

This patent application claims the benefit, under 35 U.S.C. §119(e), of U.S. Provisional Patent Application Ser. No. 62/233,308, filed on Sep. 26, 2015, the content of which is incorporated herein by reference in its entirety, and U.S. Provisional Patent Application Ser. No. 62/234,597, filed on Sep. 29, 2015, the content of which is incorporated herein by reference in its entirety.

### TECHNICAL FIELD

The present teachings relate generally to systems and methods for providing personal finance analytical tools and, more specifically, tools that automatically generate comprehensive financial recommendations and advice to individuals based on a series of inputs, the application of rules and formulas, and comparative data about others' financial situations.

### BACKGROUND

To date, individuals and their advisors have struggled in developing ways to gather, organize, analyze, and prioritize an individual's financial matters. According to most people involved, individuals are too complex and involve too many different variables to be able to retrieve all necessary variables and apply one universal methodology and set of rules to all situations. What is needed is a system that generates comprehensive financial planning recommendations to individuals. Therefore, it would be beneficial to have an alternative methodology for gathering, organizing, and analyzing an individual's relevant financial information.

### SUMMARY

The needs set forth herein as well as further and other needs and advantages are addressed by the present embodiments, which illustrate solutions and advantages described below.

What is needed is a system that generates comprehensive financial planning recommendations to individuals that may be based on: (i) that individual's responses to a set of questions and inputs; and (ii) a set of universal financial planning rules combined with comparative data from other individuals who are similarly situated and that influence such rules. In order for the system's output recommendations to be directly accessible and understandable to individuals with or without the intervention, interpretation, or manipulation from a human advisor, these output recommendations may be delivered in an advice-driven narrative format that extends beyond the usual financial data reporting.

In addition, being that recommendations made to an individual in one financial area often have a financial impact on other areas and goals, these output recommendations may extend to topics beyond the usual investments or budgeting to other financial areas and issues commonly viewed as important and relevant to individuals—such as college planning, estate planning, divorce and marriage planning, insurance and risk management, income tax planning, and/or retirement planning.

To ensure ease of adoption by individuals, the inputs required to generate such output recommendations may be limited to only those necessary to generate core output recommendations, yet allow additional discretionary inputs by such individuals in order to enhance such core output recommendations.

To provide a benchmark reference to assist in answering common “how am I doing overall?” questions from individuals, what is also needed is a simplified comprehensive financial wellness score that enables individuals to review and assess their strengths, weaknesses, opportunities, and threats across all financial areas against a total possible benchmark score. Combined, such a system may provide insights to individuals either: (i) who cannot afford to hire a legitimately independent and competent financial planner whose recommendations will not be skewed toward the purchase of financial products; or (ii) who choose not to work with a financial planner for nonfinancial reasons—such as the financial planner's inability to provide desired on-demand responses and comparative insights about other individual's financial situations, the financial planner's conflicts of interest as to recommendations to be provided, and/or a shortfall in such financial planner's competence and ability to handle multiple variables and multi-disciplinary topics at issue.

The scoring insights may also have application to third-party decision-makers seeking a forward-looking evaluation of an individual's ability to repay funds loaned, either as alternative to, or an addition to, current credit scoring systems that depend exclusively on current balances and past history without any regard to the future.

The present teachings include, but are not limited to, an individual and/or an advisor being able to use the system as a comprehensive financial monitoring tool that also enables the individual and/or an individual's advisor to obtain comprehensive financial recommendations on-demand, which are further supported and made relevant by the provision of a single comprehensive financial wellness score. The system begins as a four-stage sequence by the system first asking the individual a series of “core” questions that are required in order to use the system and advance to the next stage. Once these questions are received into the first “organize inputs” stage, the individual is permitted to advance to the next “analyze results” stage, whereby the individual can view his or her personal balance sheet, investment allocation by asset class, insurance summary, estate flowchart, and long-term cash flow projections. The individual can also review educational content within this “analyze results” stage, which forms the basis of a set of rules that are applied to generate output recommendations. The individual can then opt to incorporate any or all of these recommendations into a task list on the next “prioritize tasks” stage, where the individual will be able to add target due dates and set email and other electronic reminders, as well as review ratings given by other individuals on the system or their various advisors who might be considered for implementation of tasks by this individual. Once the individual completes any given task in the “prioritize tasks” stage, the individual is then able to upload any resulting documentation—such as an executed Will or a signed Deed—to the final “secure documents” phase for later retrieval and reference.

The method according to the present teachings includes, but is not limited to, the step of using a computer to gather financial information from an individual. Another step is generating a balance sheet automatically with the computer using the gathered financial information, the balance sheet having an asset column and a liability column. Another step is generating a cash flow projections report automatically with the computer using the gathered financial information, the cash flow projections report having year-by-year projections until a year of expected death for the individual. Another steps is calculating a financial score of 0 to 100 with the computer using the gathered financial information, the balance sheet, and the cash flow projections. The calculation includes: 1) analyzing cash flow by starting with 10 points and subtracting 1 point for each 5-year period before the year of expected death where a cash flow projection is negative; 2) analyzing debt management by starting with 10 points and subtracting 1 point for each 5% that debts represent more than 50% of assets; 3) analyzing diversification by starting with 10 points and subtracting 1 point for each 5% that a single asset exceeds 50% of total assets; 4) analyzing estate planning by starting with 10 points and subtracting 2 points if there is insufficient life insurance to replace lost earnings upon a death, subtracting 2 points if individual does not have a will, subtracting 2 points if individual has not instructed another where to find key documents, subtracting 2 points if more than 50% of the individual's estate will pass via probate, and subtracting 2 points if projected estate taxes represent more than 25% of the projected value of the individual's estate; 5) analyzing family planning by: i) starting with 5 points and subtracting 1 point for each year of marriage less than 15 where no prenuptial agreement; and ii) starting with 5 points and subtracting 5 points if getting married or having a child would result in net new outflows at a time when ending cash balances will turn negative in the next ten years; 6) analyzing disability planning by starting with 10 points and subtracting 1 point if no power of attorney, subtracting 1 point if no healthcare directive, subtracting 4 points if no major medical policy, and subtracting 4 points if no long-term disability policy; 7) analyzing property protection by starting with 10 points and subtracting 3 points if no homeowner or renter policy, subtracting 3 points if owning a car and no automobile policy, subtracting 2 points if individual does not have at least 80% of dwelling covered, subtracting 1 point if no riders on special articles of high value, and subtracting 1 point if cash holdings exceed FDIC limits; 8) analyzing legal defense by starting with 10 points and subtracting 5 points if less than 90% of net worth covered by liability insurance, and subtracting 5 points if net worth in excess of a limit for creditor exposures; 9) analyzing down-markets by starting with 10 points and subtracting 1 point for every 10 years that the individual's age exceeds a percentage of overall investments held in non-equities; and 10) analyzing demand for business by starting with 10 points and subtracting 3 points for not having a bachelor's degree, subtracting 3 points for not having a master's or professional degree, subtracting 2 points if insufficient barriers to entry, and subtracting 2 points if less than 50% of living expenses in cash accounts.

The financial score is adjusted by applying a declining 49% of value to the individual's expected financial outcome over the next 7 years, applying a straight 2% to the individual's expected financial outcome for years 8 through a remaining life expectancy, and applying a declining 49% to an unexpected situation over the next 7 years.

The declining 49% for the unexpected situation is allocated equally among the following 7 events: death, divorce/marriage, disability, property damage, lawsuit, downsizing, down-market. 1 point is subtracted for each event in each of the next 7 years for which there is a deficit.

For the straight 2%, 2 points is subtracted if the individual is projected to run out of cash during any year after year 8 through the remaining life expectancy.

A system accordingly to the present teachings includes, but is not limited to, a computer and a user interface on the computer adapted to gather financial information from the individual. A balance sheet is automatically generated by the computer using the gathered financial information, the balance sheet having an asset column and a liability column. A cash flow projections report is automatically generated by the computer using the gathered financial information, the cash flow projections report having year-by-year projections until a year of expected death for the individual. A financial score of 0 to 100 is automatically calculated by the computer using the gathered financial information, the balance sheet, and the cash flow projections report. The financial score is based on the following ten analysis principles, each weighted at 10%: 1) cash flow; 2) debt management; 3) diversification; 4) estate planning; 5) family planning; 6) disability planning; 7) property protection; 8) legal defense; 9) down-markets; 10) demand for business.

The cash flow projections report is generated by using sources of cash from the gathered financial information, adding cash inflows and subtracting cash outflows from the gathered financial information, applying a portfolio growth rate from the gathered financial information, and applying a rate of inflation.

The balance sheet is divided into further columns for a married individual, specifying whether each asset is owned separately by one spouse or jointly with rights of survivorship.

The financial score is calculated using each analysis principle as follows: 1) starting with 10 points, subtract 1 point for each 5-year period before the year of expected death where a cash flow projection is negative; 2) starting with 10 points, subtract 1 point for each 5% that debts represent more than 50% of assets; 3) starting with 10 points, subtract 1 point for each 5% that a single asset exceeds 50% of total assets; 4) starting with 10 points, i) subtract 2 points if there is insufficient life insurance to replace lost earnings upon a death; ii) subtract 2 points if individual does not have a will; iii) subtract 2 points if individual has not instructed another where to find key documents; iv) subtract 2 points if more than 50% of the individual's estate will pass via probate; v) subtract 2 points if projected estate taxes represent more than 25% of the projected value of the individual's estate; 5) i) starting with 5 points, subtract 1 point for each year of marriage less than 15 where no prenuptial agreement; ii) starting with 5 points, subtract 5 points if getting married or having a child would result in net new outflows at a time when ending cash balances will turn negative in the next ten years; 6) starting with 10 points, subtract 1 point if no power of attorney, subtract 1 point if no healthcare directive, subtract 4 points if no major medical policy, and subtract 4 points if no long-term disability policy; 7) starting with 10 points, subtract 3 points if no homeowner or renter policy, subtract 3 points if owning a car and no automobile policy, subtract 2 points if individual does not have at least 80% of dwelling covered, subtract 1 point if no riders on special articles of high value, and subtract 1 point if cash holdings exceed FDIC limits; 8) starting with 10 points, subtract 5 points if less than 90% of net worth covered by liability insurance, and subtract 5 points if net worth in excess of a limit for creditor exposures; 9) starting with 10 points, subtract 1 point for every 10 years that the individual's age exceeds a percentage of overall investments held in non-equities; 10) starting with 10 points, subtract 3 points for not having a bachelor's degree, subtract 3 points for not having a master's or professional degree, subtract 2 points if insufficient barriers to entry, and subtract 2 points if less than 50% of living expenses in cash accounts.

The year of expected death is 100.

The limit for creditor exposures is $50 million.

The key documents comprise account statements, insurance policies, tax returns, and estate planning documents.

The barriers to entry comprise intellectual property, capital intensity, or another barrier as assessed by the individual.

The computer transmits the balance sheet and cash flow projections report to the individual.

An interface links accounts of the individual at third-party financial institutions so that the system can automatically download transaction data for those accounts.

The individual can upload financial-related documents for storage in the system.

The computer comprises a plurality of computers communicating with each other over a network.

The interface on the computer comprises a webpage. There is a webpage for gathering each category of facts from the individual.

The system according to the present teachings also includes, but is not limited to, a computer and a user interface on the computer adapted to gather financial information from the individual. A balance sheet is automatically generated by the computer using the gathered financial information, the balance sheet having an asset column and a liability column. A cash flow projections report is automatically generated by the computer using the gathered financial information, the cash flow projections report having year-by-year projections until a year of expected death for the individual. A financial score of 0 to 100 is calculated by the computer using the gathered financial information, the balance sheet, and the cash flow projections report. The financial score is based on ten analysis principles, each weighted at 10%.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic diagram of one embodiment of the system according to the present teachings.

FIG. 2 is a flow chart according to the system of FIG. 1.

FIG. 3 is a flow chart for collecting and aggregating financial data according to the present teachings.

FIGS. 4A-4T are exemplary screen shots of various financial reports generated by the system of FIG. 1.

FIGS. 5A-5E are exemplary screen shots of a comparative scoring formula for the system of FIG. 1.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

A methodology for financial analysis according to the present teachings may be universally applied to all users. It may approach each user's situation in stages: first, gather key facts (e.g., may be 10 standard categories of questions) about the user; second, organize those facts into a balance sheet and long-term cash flow report; and third, analyze the user's entire financial situation. The key facts, balance sheet, and long-term cash flow may be scored for analysis, with individual weights assigned based upon the importance of protection in a category. The results of the analysis may allow the user to prioritize different areas of the financial situation, as well as to review the situation overall.

The methodology may include asking the user to gather facts in order from most to least relevant to analysis, to assist those individuals in making informed financial decisions to save time and money. These facts may be divided into two levels, starting with more basic information in Level 1 “core” and then addressing more details and hypotheticals in Level 2 “advanced” versions. The underlying theory behind the gathering of facts is to thereafter be able to build a balance sheet and long-term cash flow projection—two important reports the user can use in order to analyze his or her financial situation.

Gathering facts in Level 1 “core” may include the most relevant facts in order to conduct a comprehensive financial analysis for an individual. These may include the following ten questions:

(i) The individual's date of birth.

(ii) The individual's' employment status—may be defined as “working,” “retired,” “disabled,” or “seeking employment”—and at least one “salary” inflow if the individual indicated a “working” employment status. The individual will also be able to enter in other future inflows as applicable at this point—such as a future inheritance, pension, annuity, bonus, insurance proceeds, government assistance, business distributions, or trust distributions.

(iii) The individual's marital status—may be defined as “single and never married,” “partnered and never married,” “divorced and not remarried,” “divorced and remarried,” “divorced and partnered”—as well as the name, date of birth, and employment status of such spouse or partner if the status is not “single and never married,” as well as an inquiry as to whether alimony was being paid or received and for what amount and period, if the individual indicated a status other than “single and never married” or “partnered and never married.”

(iv) The individual's number of children and if other than “0,” those children's names, dates of birth, and the value of any accounts set aside for such children.

(v) The value of at least one asset owned by the individual along with an indication of its type—specifically, “checking account,” “savings account,” “CD,” “brokerage account,” “managed taxable investment account,” “401k account,” “Traditional IRA account,” “Roth IRA account,” “personal property,” “real estate,” “business interests,” or “executive compensation.” The individual will be given an opportunity to link any financial accounts (which include both asset and liability accounts) to their outside institution so that their financial data feeds into the system in real-time and maintains continuous relevance. The individual will also be asked whether any of these assets are scheduled to be sold in the future, and if so, in which year.

(vi) For any investment accounts, retirement plan accounts, or accounts listed as set aside for children that the individual has not linked to their outside institution, the system may ask for a basic indication of how the investments are allocated per account, notated by a percentage in “equities,” “tax-exempt bonds,” “taxable bonds,” “cash” or “alternative investments” (investment accounts that are linked should automatically indicate underlying holdings and classify these holdings by asset class).

(vii) An inquiry as to whether any liabilities exist—and if so, what the value, interest rate, remaining term, and type is. The types to be included may be “credit card,” “loans against investments,” “loans against personal property,” “loans against real estate,” or “student loans.” If the individual indicates that a loan exists against a certain asset such as investments, personal property, or real estate, the system may request that the loan type be matched against its corresponding collateral asset as entered previously.

(viii) An inquiry as to whether certain insurance types exist—namely, disability, umbrella, life, long-term care, homeowners/renters, automobile, and medical/dental/vision—and, if so, through which insurance companies. If the individual indicated a “working” employment status in previous questions, the system may specifically ask whether a long-term disability policy is in place to replace such earnings in the event of disability, and whether this policy was obtained through work or individually in order to apply taxation to benefits received. Similarly, if the individual indicated that a home and/or automobile asset was owned, the system will specifically inquire whether a corresponding homeowner's or automobile insurance is in place for such assets. After asking about these specific insurance policies, the system may ask about the existence of any of the other types of policies. Any indication of umbrella or life insurance may include an indication of the benefit amount in order to maintain relevance, and the life insurance policy may further be listed as either whole, term, variable, or universal. Finally, if insurance premiums are known, those should be entered on a per-policy basis.

(ix) An estimate of monthly living expenses—defined as an aggregate of day-to-day discretionary and nondiscretionary expenses (exclusive of insurance premiums, liability repayments, taxes, and support of charities and family members) to include shopping, travel/vacation, enrichment activities, food/consumption, home-related costs, automobile/transportation, and services of others such as beauticians, doctors, and domestic support. These each may include a question mark pop-up for the individual to be able to view what is included in such categories. The underlying subcategories can be detailed by the individual at a later point in advanced stages, but may be too involved for this core questionnaire.

(x) The system may finally provide the individual with an opportunity to upload documents to certain folders (which will be accessible in the final “store documents” stage and later generate a recommended task to remind to upload a document if the system recognizes an empty folder), and to confirm or change a set of pre-set assumptions. These ten assumptions may include: (i) that the individual and the individual's spouse/partner, if applicable, are US Citizens and not Resident Aliens or Non-Resident Aliens; (ii) that the individual and the individual's spouse/partner both intend to retire fully when they each turn age 65; (iii) that the individual's disability policy, if applicable, involves a 90-day elimination period and thereafter provides 60% of salary up to $15,000 per month through age 65; (iv) that social security will be taken at each individual's applicable full retirement age, as defined by the Social Security Administration, and that the full number of qualifying credits have been earned; (v) that required minimum distributions will be delayed on each individual's retirement accounts until each individual turns age 70.5, unless required due to cash flow deficits and no other non-retirement financial assets are available; (vi) that the long-term inflation rate will be 4% and will apply to increases of salaries, living expenses, and insurance premiums, and that employment is stable; (vii) that the broad investment category of “taxable bonds” are assumed to match the subclass allocation of bond types included in the Barclays Aggregate Bond Index and “tax-exempt bonds” are assumed to match the allocation of bond types included in the Barclays 5-Year Muni index, that the broad investment category of “alternatives” is assumed to include an equal weighting to commodities, hedge funds, private equity, options, and investment real estate, that the broad investment category of “equities” is assumed to mirror 60% of the S&P 500 index, 20% to the Russell 2000 index, 15% to the MSCI EAFE index, and 5% to the MSCI Emerging Markets index, and the portfolio growth rate is applied based on historical growth rates for each index applicable to the individual's time horizon; (viii) that the applicable titling is joint with rights of survivorship in the case of couples; (ix) that the applicable state's child support guideline amounts are the amounts used as “support of others” for children until they each reach age of majority, regardless of whether married or divorced; and (x) that the underlying liability limits required in any umbrella liability in any homeowner's/renter's or automobile policy are met.

Once the individual enters the “core” Level 1 facts, the individual may then proceed to the second stage to “Analyze Results.” This stage will allow the individual to view his or her personal balance sheet, investment asset class allocation across all accounts, insurance summary report, income tax projections, and long-term cash flow projections. Within the long-term cash flow projections, the individual will be able to run hypothetical projections on-demand to review the long-term impact of a change in a certain variable—such as a change in retirement date, lower or higher living expenses, a change in alimony amount or duration, a sale of an asset, or a change in portfolio growth rates. Once the individual moves away from this hypothetical projection screen, all of the original inputs may reset to the original state, so that the individual is at liberty to manipulate variables without fear of disrupting base inputs.

To change or elaborate on the original inputs, the individual can also return back to the prior “Organize Inputs” stage and input additional information as a “Level 2” enhancement to the original inputs. The individual may wish to input additional nonessential inputs for Level 2, such as the applicable deductible, coinsurance or coverage amounts of insurance, the applicable titling of assets, detailed living expense breakdowns, the type of business entity owned and business cash inflows, outflows and distributions, and the contact information of their other advisors—such as their attorney, accountant, insurance representative, and investment manager/private banker—along with an applicable performance rating for review in aggregate form by other users, if desired.

Organizing the facts for purposes of the “Analyze Results” stage may involve taking the facts that were gathered and placing them into either a personal balance sheet, a long-term cash flow report, or, in some cases, both.

Balance Sheet.

The information obtained in the “Organize Inputs” stage can be directly placed into the “asset” column or “liabilities” column to construct the personal balance sheet. In the case of married individuals, titling may be divided into further columns before reaching the total value, in order to specify whether the asset is owned separately by one spouse or jointly with rights of survivorship. Columns for “rate” and “remaining term” may be added to “Liabilities” in order to quickly view such critical information at a glance.

Long-Term Cash Flow Projections.

The first two categories of the balance sheet (e.g., cash accounts and investment accounts) may serve as the starting point for constructing the long-term cash flow report, since cash and investments are a ready source of cash. From there, cash inflows (e.g., as stated in the “core” interview series) may be added and then cash outflows (e.g., as stated in interview questions) may be subtracted (e.g., except “tax payments,” which may be a formula that applies ordinary income tax rates to cash inflow items listed as “salary,” “retirement plan withdrawals,” “alimony,” “bonus,” and “government assistance,” and applies capital gains tax rates to items listed as “asset sale proceeds”). Then, the portfolio growth rate specified above may be applied to the beginning balance of “investments” and added to arrive at the ending year balance. This ending year balance may become the beginning year balance for the next year, with the inflows and outflows adjusted at a rate of inflation and the first year's inflows, outflows and portfolio activity being pro-rated for the starting month.

An overall financial protection score may be calculated using the gathered facts, the generated balance sheet, the generated cash flow projections, the extent of comparative and relative financial impact, and the application of a set of rules and formulas. The theory underlying the creation of a comprehensive financial analysis is often viewed as difficult due to different stated objectives of each individual user. However, this computation assumes there are certain universal truths regarding fundamental goals applicable to all individuals—such as a desire to not change one's lifestyle.

A comprehensive scoring system has been developed according to the present teachings, with the highest score being “100” and the lowest being “0”. The score may be based upon an average of two underlying scores—one which will be referred to as the “Equal Weighting Score,” which assumes that ten broad issues are of equal importance to all individuals and remain relevant through life expectancy, and the other which will be referred to as the “Comparative and Relative Impact Score,” which assumes that issues are only relevant to the extent of probability of occurrence, impact on lifestyle and the attainment of other objectives, variation as measured against other individuals who are similarly-situated, and, in any event, are of declining relevance after seven years due to inherent speculation regarding the application of variables at such a point into the future.

The “Equal Weighting Score” may be summarized as follows:

1. Cash Flows & Lifestyle (10%).

Individuals generally do not want to have to change their lifestyle (e.g., living expenses) in the future due to a scarcity of cash. Therefore, the system may look at the individual user's long-term cash flow projections (e.g., from generated cash flow projections report) to see if there is a positive or negative ending balance in the year of expected death (e.g., may be determined to be age 100) given expected future assumptions. If the balance is positive at that age based on the individual's expectations of inflows, outflows and portfolio activity, the user may receive the full 10 points in this category (e.g., the 10%). If the balance is not positive at that age, the user may lose 1 point for each 5-year period where the year-end balance is not positive, up to the maximum loss of 10 points, starting at age 100 and working backwards. So, for the expected death age of 100, if the user has a positive ending balance at the end of the year in which the user turns 90 and is positive for every year prior, but is not positive at the end of the year in which the user turns 95 or 100, the user receives a score of “8.” Similarly, if the user runs negative at the end of the year in which the user turns 80, but is positive at the end of the year in which the user turns 75 and in every year prior, the user would lose points for 100, 95, 90, 85 and 80—and thus would only receive a “5.”

2. Debt Management (10%).

Individuals generally do not want to take on debt in amounts that cannot be repaid without sacrifices to other objectives or a change in lifestyle. If the amount of debt is exactly the amount of assets (e.g., based on amounts listed in the generated balance sheet), the individual could theoretically pay off all debts with all assets but would thereafter have no other assets and would need to rely upon new cash inflows in order to survive. This case (or the even worse case of a negative net worth) is the situation most individuals wish to avoid, and thus may result in a scoring of “0” in this category. To the contrary, when an individual can pay off debts two times over (or more) using existing assets, the full “10” points may be awarded. In the middle is where total debts start to represent 50% or more of total assets. For each 5 percentage points at which debts represent more than 50% of assets, 1 point may be reduced. So if a user's debts represent 66% of assets, that user may receive a score of “7” in this category—having lost a point at 55%, a point at 60%, and a point at 65%. The individual may also lose 1 point to the extent that any after-tax liability rate exceeds any after-tax expected appreciation rate on financial assets, or may gain 1 point when the opposite is true.

3. Diversification (10%).

Individuals generally want to make sure that their assets are well-diversified, both in terms of their investments and their total net worth. Otherwise, they become excessively exposed to risks that could adversely impact their overall net worth. Therefore, the system may test whether any single asset represents more than 50% of total assets (e.g., based upon values listed on the generated balance sheet). The extent to which a single asset exceeds 50% of total assets may subtract 1 point for each 5% above the 50% threshold point. So a user with a single asset representing 72% of total assets may receive a score of “6” in this category, due to a loss of 4 points for reaching the 55%, 60%, 65% and 70% marks. A user with a single asset concentration representing 100% may receive a “0” while a user who did not have any single asset concentrations exceeding 50% may receive the full score of “10”.

4. Estate Planning (10%).

Individuals generally want to make sure: (i) that their death, or the death of their spouse, does not cause a change in lifestyle (e.g., in living expenses) to their surviving dependents—as assessed by the existence or non-existence of life insurance to replace any lost earnings of the deceased; (ii) that at least a will is in place to ensure that intentions are fulfilled; (iii) that burdens on heirs to locate key documents (and find passcodes, etc.) are minimized; (iv) that the necessity to reassign title and ownership through the probate process is minimized; and (v) that projected estate taxes are minimized. Each of these five categories may be awarded 2 points.
Category (i) may ask whether sudden death of either spouse would result in a necessary change in living expenses for the surviving spouse or dependent children, taking into account any life insurance to replace lost earnings. If living expenses must be adjusted due to either death or both deaths, 2 points may be deducted.
Category (ii) may test whether the individual has a will (as requested in fact gathering). If no, then 2 points may be deducted.
Category (iii) may test whether the individual has informed anyone else of where to find key documents and passcodes (as requested in fact gathering). If no, then 2 points may be deducted.
Category (iv) may test whether title and ownership through the probate process is minimized (e.g., indicated by more than 50% of the deceased's gross estate passing via probate instead of via rights of survivorship, beneficiary designation, or via trust; for example, fact gathering may ask detailed questions about the scope of any will). If no, then 2 points may be deducted.
Category (v) may test whether projected estate taxes are minimized. If projected estate taxes represent more than 25% of the projected value of deceased's gross estate—assessed as if the individual passed yesterday—the answer is “no” and 2 points may be deducted.

5. Planning for Marriage, Divorce or Other Family Changes (10%).

Individuals want to make sure that getting a divorce, getting married, or having a child will not adversely impact their lifestyle. If the individual is married within the past 10 years—or about to get married—and does not have a pre-nuptial agreement and has no plans to secure a post-nuptial agreement (e.g., as questioned in fact gathering), 5 points may be deducted due to the financial drain of the divorce settlement process. Each year of marriage beyond year 10 lifts 1 point on the reduction that would otherwise be 5 points. So a couple married 19 years that does not have a prenuptial or post-nuptial will not receive any reduced points, but if that same couple were only married 11 years 4 points would be reduced. Similarly, if getting married or having a child would result in net new outflows at a time when ending cash balances will turn negative in the next ten years, 5 points may be deducted. So a married couple who has a pre-nuptial agreement in place but is expecting a child at a time when their long-term cash flow projections show that they run out of cash in the next 10 years even without the child may receive a score of “5” for this category.

6. Planning for Disability or Severe Illness (10%).

Individuals want to make sure that becoming disabled or severely ill will not adversely impact their family's ability to maintain their current lifestyle. Therefore, not having a power of attorney may reduce 1 point, not having a healthcare directive may reduce 1 point, not having a major medical policy may reduce 4 points and not having a long-term disability policy may reduce 4 points.

7. Property Protection (10%).

Individuals want to make sure that sudden damage to property from an accident, theft, fire or similar event will not cause harm. Therefore, not having a basic homeowner's or renter's policy may reduce 3 points, not having an automobile policy when owning a car may reduce another 3 points, not having at least 80% of dwelling covered will reduce 2 points (since smaller claims will be reduced), not having riders on special articles of high value may reduce 1 point, and having too much cash beyond FDIC limits may reduce 1 point.

8. Defense in a Lawsuit or Tax Audit (10%).

Individuals want to make sure that their net worth will not fall if they are held liable in a lawsuit. Not having at least 90% of net worth (e.g., outside of retirement accounts and business interests) covered by liability insurance may reduce 5 points. Further, having a net worth in excess of some limit (e.g., $50 million) may reduce points to the extent of 1 point for each $10 million in excess due to greater creditor exposures at greater net worth levels and difficulty maintaining full liability coverage. So if an individual's net worth is $67 million and at least 90% of exposed net worth is covered by liability insurance, the score in this category may be a “9” (due to exposure increasing once exceeding $60 million in net worth).

9. Down-Markets (10%).

Individuals want to make sure that recessions and severe market downturns do not adversely impact their lifestyle. Therefore, individuals whose age exceeds the percentage of their overall investments held in non-equities may reduce by 1 point for each 10-point difference. For example, a 70-year old who holds 60% in equities (and 40% in non-equities) may have a 30-point difference that would result in a 3-point reduction. So that individual may receive a score of “7” in this category.

10. Diminishing Demand for Employment/Business (10%).

Individuals want to make sure that demand for their services—whether through their own individual employment or through a business owned by them—will not suddenly decline and leave them without an ability to earn an income. Therefore, not having a bachelor's degree will reduce 3 points, not having a master's or professional degree will reduce another 3 points, being a business owner without intellectual property (or other protections), high capital intensity or other similar barriers to entry (as assessed by the individual) may result in another 2-point reduction, and not having at least 50% of living expenses in cash accounts (as an emergency fund reserve) may result in another 2-point reduction.

The results of the above weightings may provide the “Equal Weighting Score.” The “Comparative and Relative Impact Score” may then apply a declining 49% of its value to the expected financial outcome of the individual's upcoming 7 years, a straight 2% to the expected financial outcome of year 8 through remaining life expectancy, and a declining 49% to the unexpected situation in the next 7 years involving the events of death, divorce or marriage, disability or severe illness, damage to property, defending against a lawsuit, downsizing/layoffs or other unexpected work changes, or down-markets.

The “Comparative and Relative Impact Score” may apply a loss-based approach—meaning that the individual starts with a full number of points but gradually loses points as the system identifies risks. The system may start with the expected situation, assuming that the unexpected events of death, disability or severe illness, divorce or marriage, damage to property, defending assets against a lawsuit, downsizing, or down-market do not occur. It may then stress-test cash flows on the assumption that these events do occur.

i. For the death scenario, the system assumes that salary of deceased stops, life insurance is paid, estate assets under control of the deceased are distributed pursuant to applicable Will and/or applicable non-probate transfers (if any, otherwise according to intestacy rules), and the IRS is paid its portion of wealth transfer taxes or income in respect of decedent (IRD) taxes.

ii. For the disability or severe illness, the system assumes that medical costs increase but are covered to some extent by existing medical insurance. And if earnings are no longer possible, it assumes that any applicable disability and/or long-term care benefits start to be paid (after any applicable elimination period).

iii. For the divorce scenario, the system assumes joint assets and liabilities are divided evenly, and that no alimony is awarded unless that individual's income is insufficient to support one-half of total cash outflows, in which case the system makes adjustments for some alimony payments to be made to even the balance for some period of time not to exceed the duration of the marriage. It assumes that child support amounts continue to be paid.

iv. For the down-market scenario, the system assumes a recurrence of the worst performance year of each of the current asset classes in the past 80 years.

v. For the downsizing scenario, the system assumes a loss of employment by both individuals, if a couple, and the longest time period for a new job to be secured in recorded history.

vi. For the damage to property scenario, the system assumes a loss of property due to fire or other destruction, and tests for whether current insurance will cover such property and—if not, whether existing financial assets are sufficient to self-insure.

vii. For defending in a lawsuit scenario, the system assumes a successful lawsuit judgment against the individual. The system will test whether homeowner's, automobile and umbrella liability coverage can cover this judgment—and if not, whether existing financial assets are sufficient to self-insure.

For the potential 49% points to be lost due to the expected financial situation, the individual stands to lose 7 points in the first year, 6 points in the second year, 5 points in the third year, and so forth until the seventh year ends. These potential point losses are then multiplied against the percentage of which any given year's deficit relates to its beginning year financial assets. For example, if in the first year, beginning financial assets were $100,000, cash inflows were $100,000, cash outflows were ($120,000) and portfolio growth was $10,000, net deficits would be ($10,000), which is 10% of the beginning financial assets balance of $100,000. The potential loss of 7 points is therefore multiplied by 10%, thus only resulting in a tentative loss of (0.7) points. If the same situation had resulted the following year, it would have been a potential loss of only 6 points, which would have resulting in a lesser (0.6) points.

Furthermore, being that the deficit amount could in theory be adjusted based on the level of discretionary cash outflows, it may benchmark not only the deficit amount against the beginning financial assets, but also against discretionary cash outflows. Therefore, the tentative score above may be further multiplied by the percent of deficit relative to the discretionary outflows—this time using a declining scale starting at a slightly lower (6) points in the first year and declining by one point for each year thereafter. So, using the example above for the first year, on an assumption that $20,000 of the $120,000 cash outflows were discretionary, the net deficit amount of $10,000 would be 50% of the $20,000 discretionary outflows. Thus, the 6 potential points to be lost would be reduced by 50% and only reduced to (3) points.

The next 2% may simply be a binary “yes/no” response as to whether the individual runs out of cash between years 8 and life expectancy. If so, 2 points are lost.

The remaining 49% may allocated equally among 7 distinct events—namely testing for the impact of death, disability, divorce, down-markets, downsizing, damage to property, and defending assets in a lawsuit—with a 1 point loss allocated to each of the next 7 years for which there is a deficit. In years of deficits, this 1 point loss may be multiplied by three factors for each year: (1) the percentage by which any deficit amount resulting from the event relates to the amount of beginning financial assets; (2) the percentage by which any deficit amounts resulting from the event relates to the amount of discretionary outflows; and (3) a probability and impact factor unique to the event.

The probability and impact factor unique to the event may include the following:

Death and Disability Events—

The individual's age plus 1 for each year after the starting year through year 7, plus 20 if the individual indicated “bad health,” expressed as a percentage up to 100%.

Divorce Events—

If married less than 7 years in applicable year+no pre/postnuptial, the applicable percentage is 100%. If married more than 7 years in applicable year and no pre/postnuptial, 75%. If married less than 7 years in applicable year and pre/postnuptial, 50%. If married more than 7 years in applicable year and pre/postnuptial, 25%.

Damage to Property—

If no homeowner's or renter's policy is in place, the applicable percentage is 100%. If a homeowner's or renter's policy exists, the applicable percentage is the percentage of property not covered by insurance.

Defending Against a Lawsuit—

If no homeowners, renters, auto, or umbrella policies are in place, the applicable percentage is 100% minus the percentage of net worth comprised of exempt assets, plus 1% for each million net worth exceeds some limit (e.g., $10 million), not to exceed 100%. If a homeowner's, renter's, automobile, umbrella policy exists, the percentage of net worth not covered by liability coverage aside from exempt assets is the applicable percentage, plus 1% for each million net worth exceeds limit (e.g., $10 million), not to exceed 100%.

Down-Markets—

The applicable percentage is the weighted probability of portfolio loss in any given year over the long term based on historical loss rates of each asset class, multiplied by the severity of such loss and expressed as a percentage loss of total investable assets.

Downsizing—

The general economic unemployment rate plus 25% if the individual received a graduate school degree, or 50% if no graduate degree but achieved a bachelors education, or 75% if no bachelor's education, plus 20% if individual listed the industry or employer as “unstable.”

As one final step, if any of the following facts are true or above zero, each may be multiplied by 1 potential point of loss:
1. The individual does not have a Will.
2. Percentage of Assets Transferring via the Probate Process in lieu of Non-Probate form.
3. Percentile of Estate Taxes to be Paid Currently Relative to Others with Similar Net Worth Range, defined as individuals within $5 million net worth.
4. Percentile of Investment Fees Currently Relative to Others with Similar Net Worth.
5. Percentile of Insurance Premiums Currently Relative to Others with Similar Net Worth.
6. Percentile of After-Tax Interest Rate Paid Relative to Others with Similar Net Worth.
7. Does not Check Credit Annually.
8. Does not have Six Months Living Expenses as Emergency Fund.
9. Percentage of Liabilities involving After-Tax Interest Rates Exceeding Expected After-Tax Asset Appreciation Rates.
10. Percentage of Emergency Funds not FDIC-Insured.

As discussed above, the average of these two scores may lead to the final financial wellness score.

The aggregate score of these factors, each weighted at 10 points, will produce a result from 0 to 100. Similar to conventional grading, a score in the 90's may represent an “A,” a score in the 80's a “B,” a score in the 70's a “C,” a score in the 60's a “D” and a score in the 50's or lower an “F.” This score represents the TOTAL ALIGNMENT® financial wellness score.

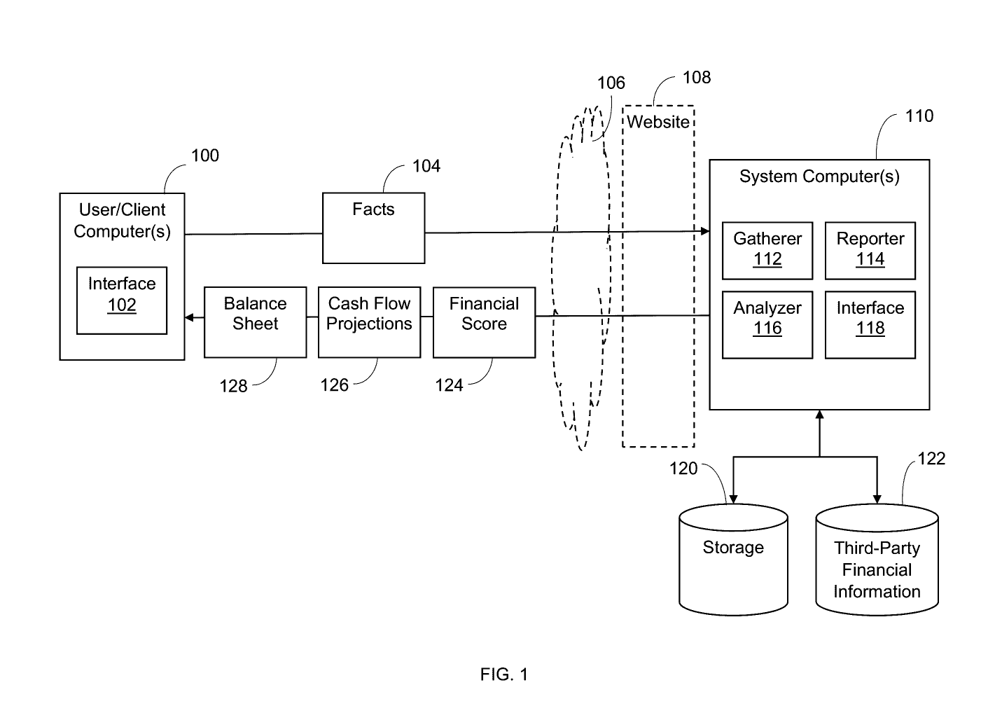

Referring to FIG. 1, shown is a schematic diagram of one embodiment of the system according to the present teachings. The user 100 may log on/connect to a computer 110 (e.g., may be a server) to access functionality. The user 100 may utilize his or her own computer having an interface 102 (e.g., downloaded web page, application, etc.). The user 100 may connect to the computer 110 over the internet 106 using a website 108 (or other interface 118). In an alternative, the user 100 may directly use computer 110.

The computer 110 may provide functionality to carry out the methodologies described herein. This may be provided by software executing on computer-readable media. Functionality may be provided in modules 112, 114, 116, 118 that may comprise separate software applications, or may be parts of a larger software application, as is appreciated by one skilled in the art.

The user 100 may provide all of the facts 104 as discussed above during the fact gathering stage. The computer 110 may provide an interface 102, 108, 118 having a graphical user interface for achieving this objective. The computer 110 may gather 112 the facts and store them in a storage 120. The computer 110 may generate reports 114 using the facts 104, including balance sheet 128 and cash flow projections 126 as discussed above, which may be sent to user 100. The computer 110 may also analyze 116 the facts 104, balance sheet 128, and/or cash flow projections 126 in order to calculate a financial score 124 as discussed above, which may be sent to user 100. The computer 110 may also rely on third-party financial information 122, including tax regulations, aggregated financial data, etc. in order to assist user 100 in financial analysis, as is appreciated by one skilled in the art.

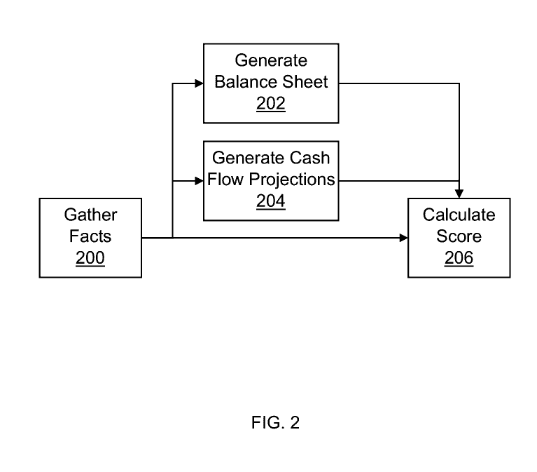

Referring to FIG. 2, shown is a flow chart according to the system of FIG. 1. As shown, the system may first gather facts 200, which it may use to generate a balance sheet 202 and cash flow projections 204. The facts 200, balance sheet 202, and/or cash flow projections 204 may be used to calculate a financial score 206 as discussed above.

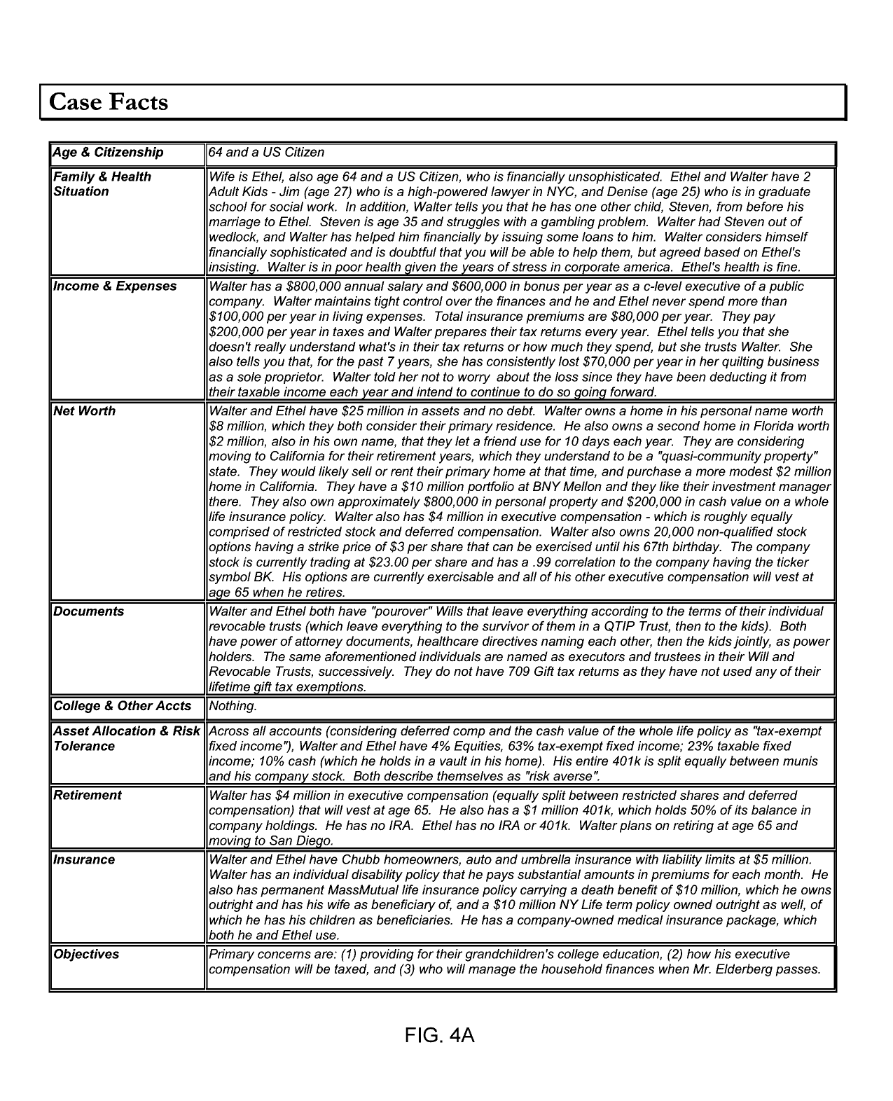

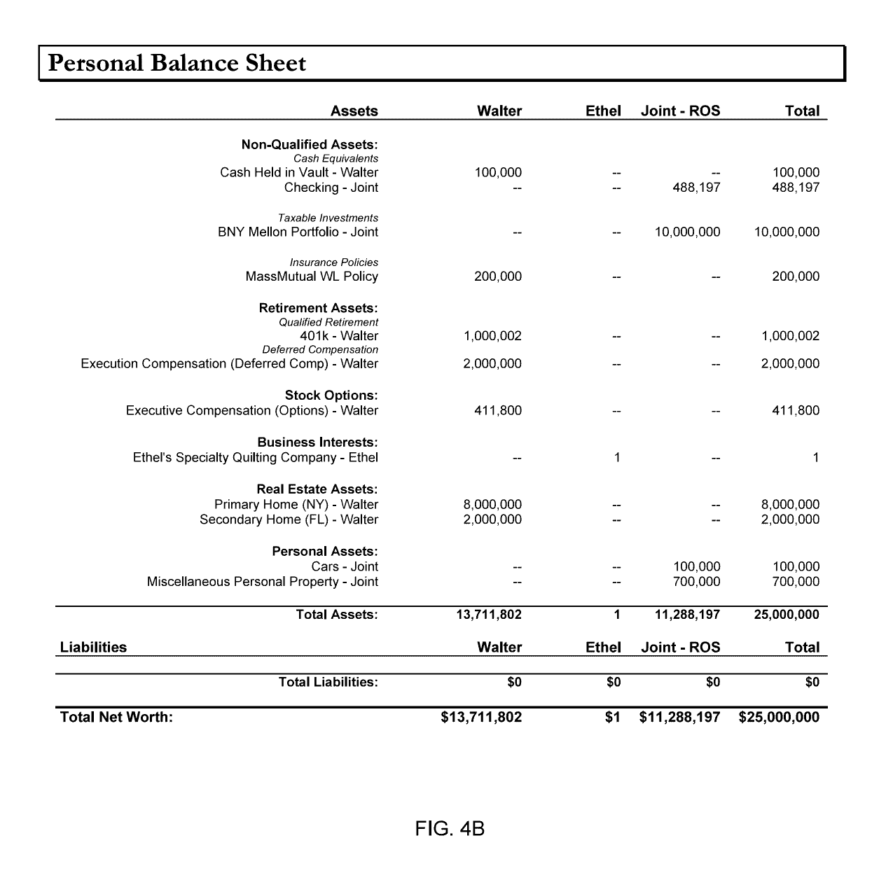

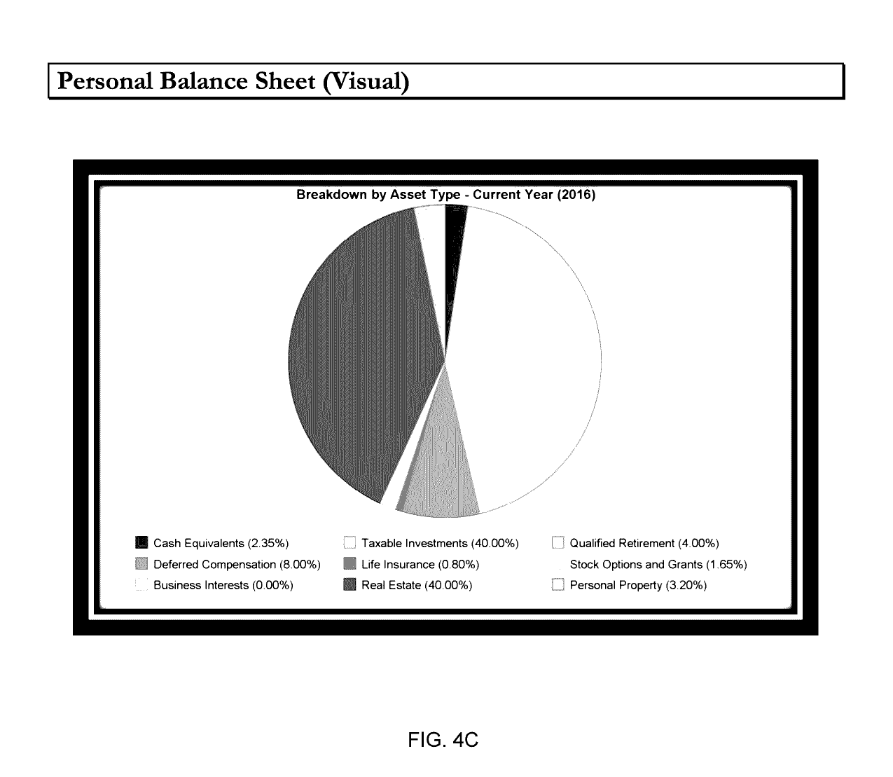

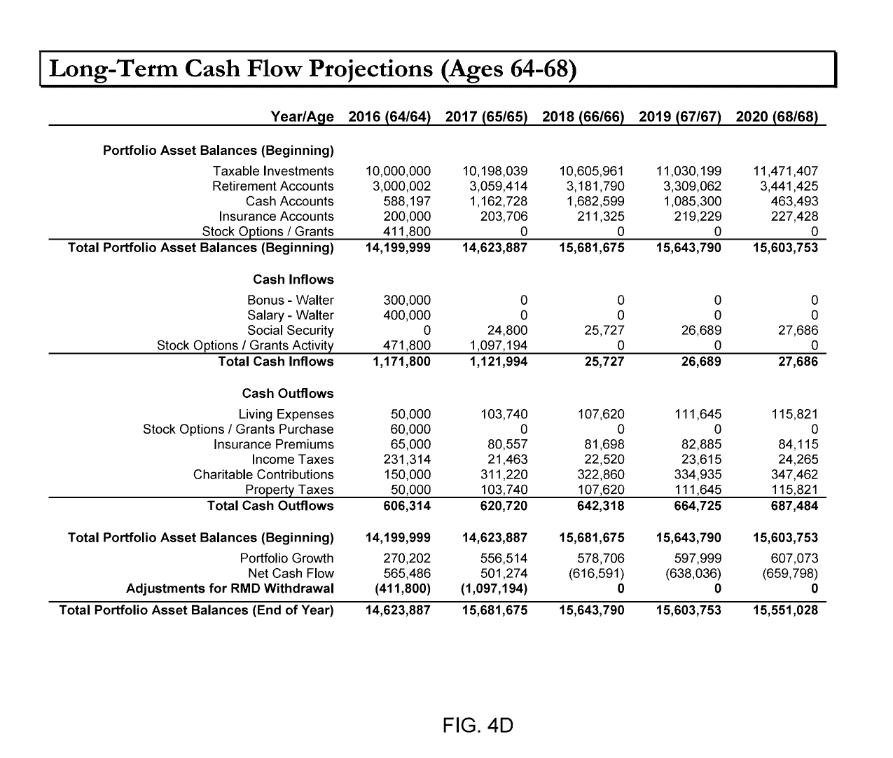

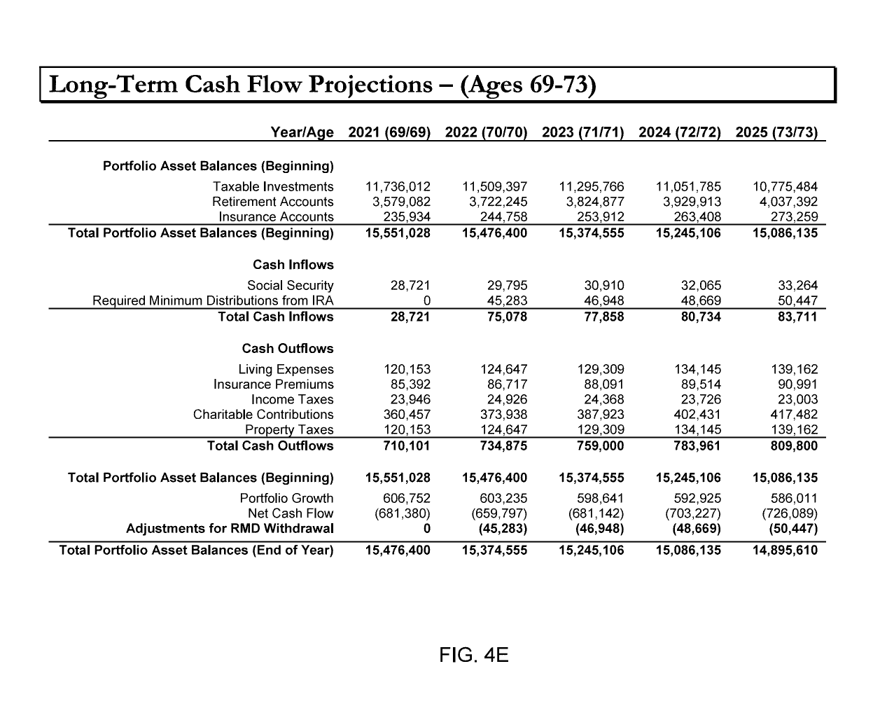

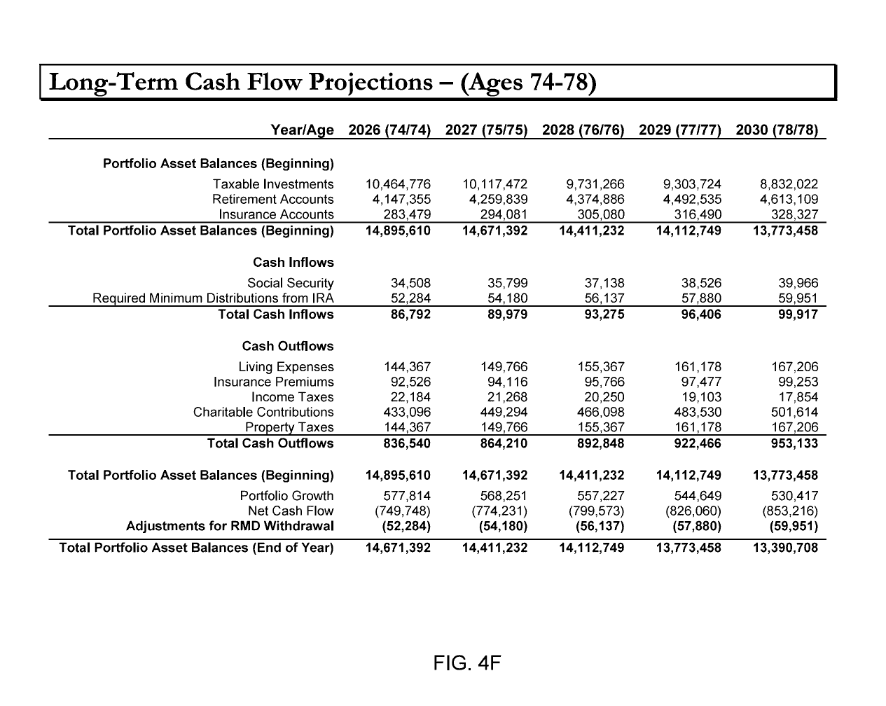

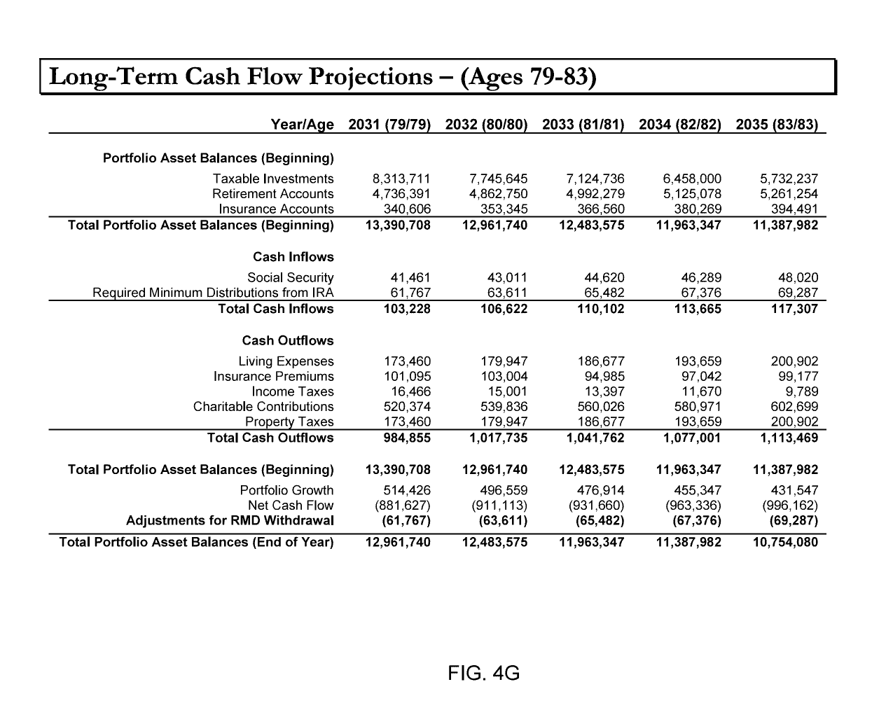

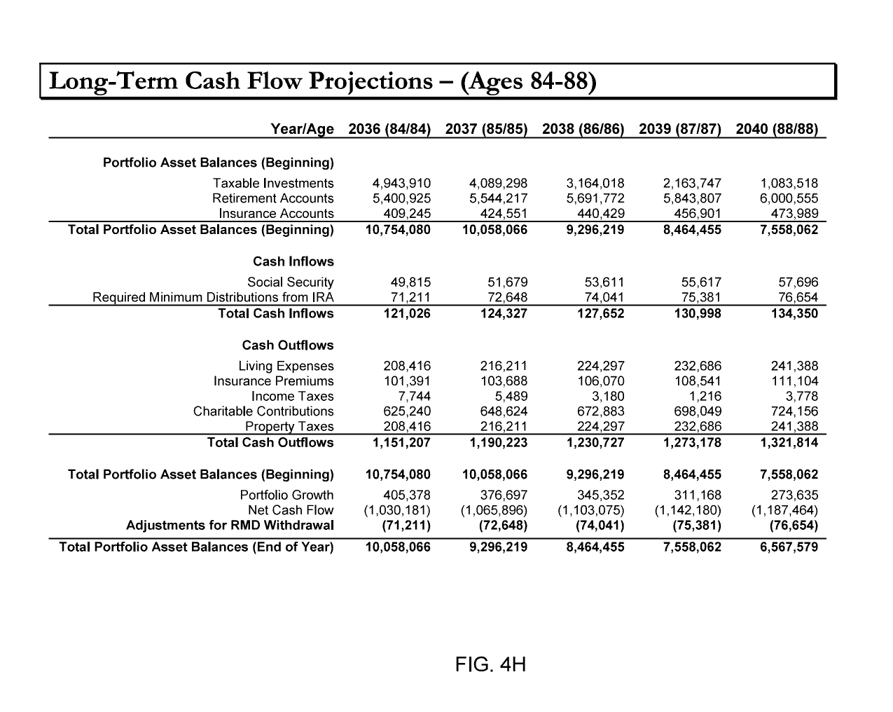

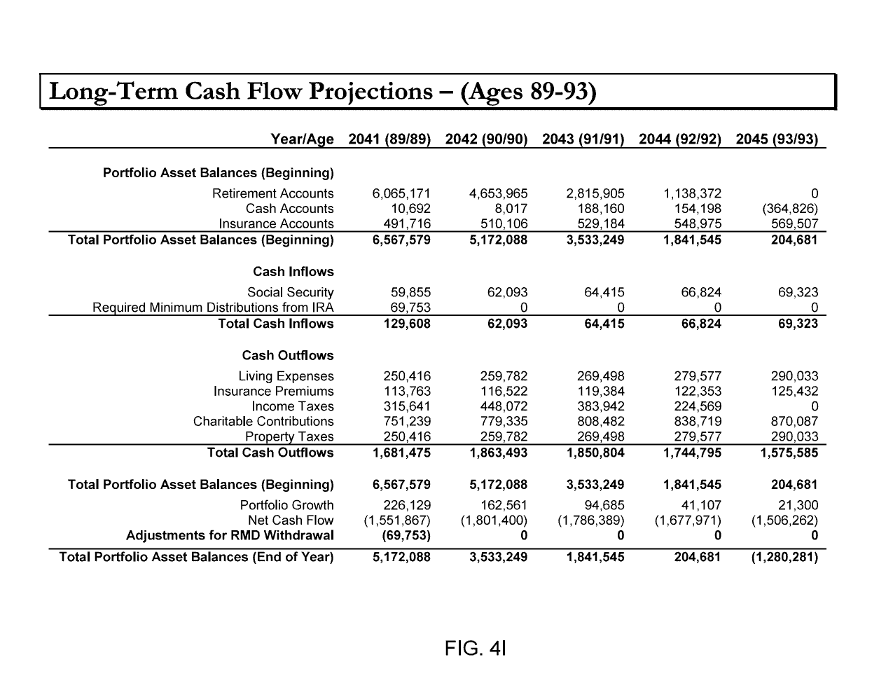

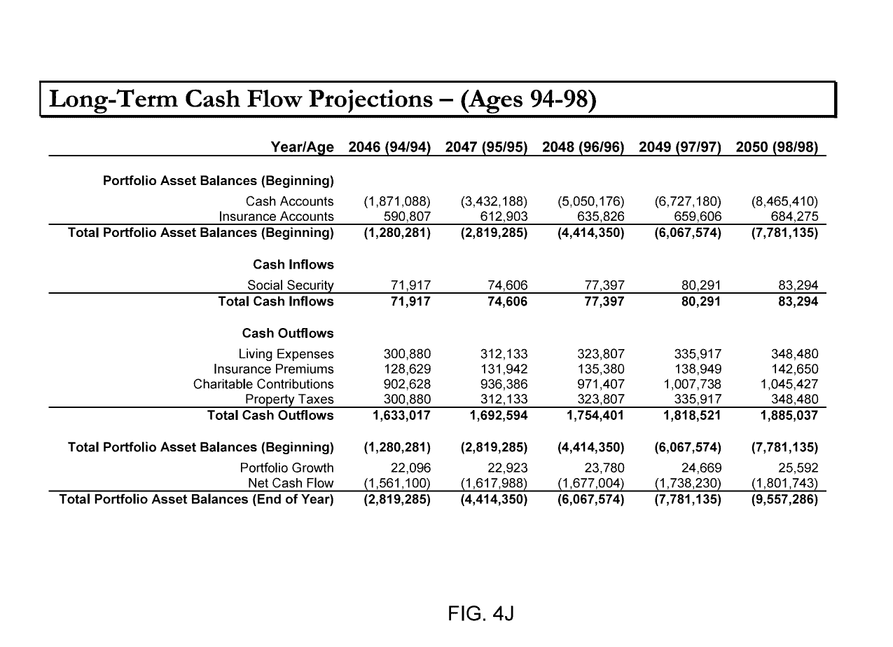

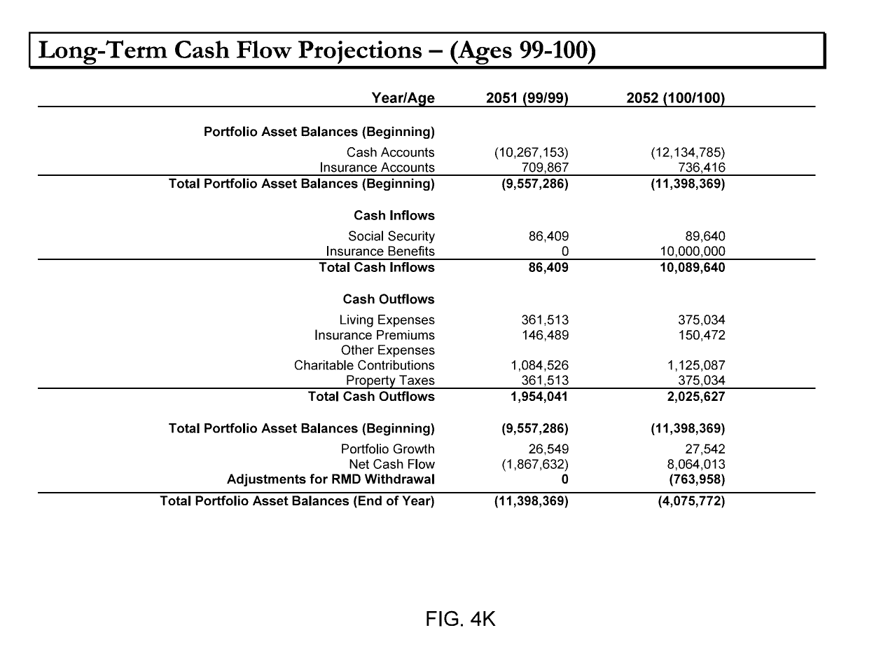

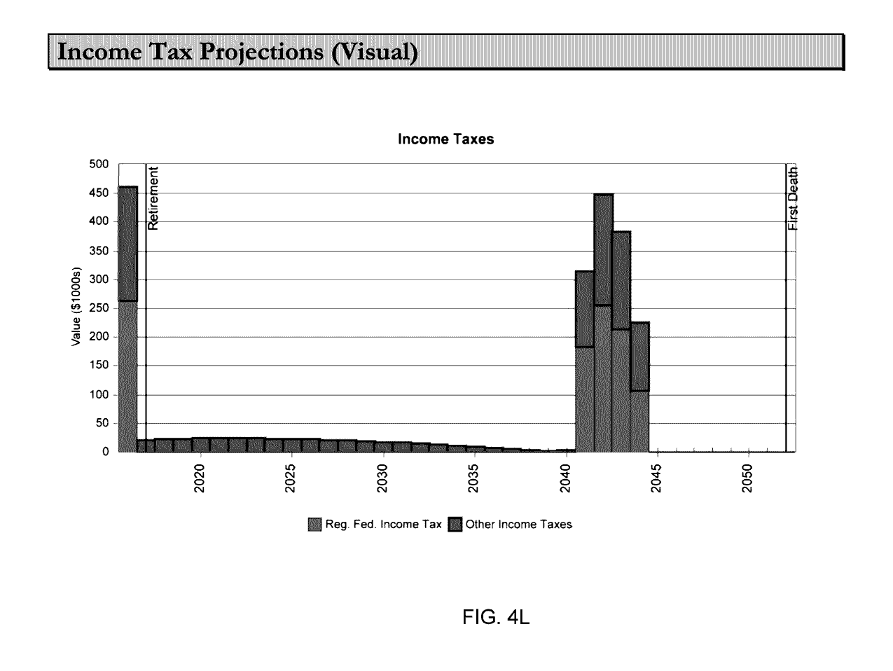

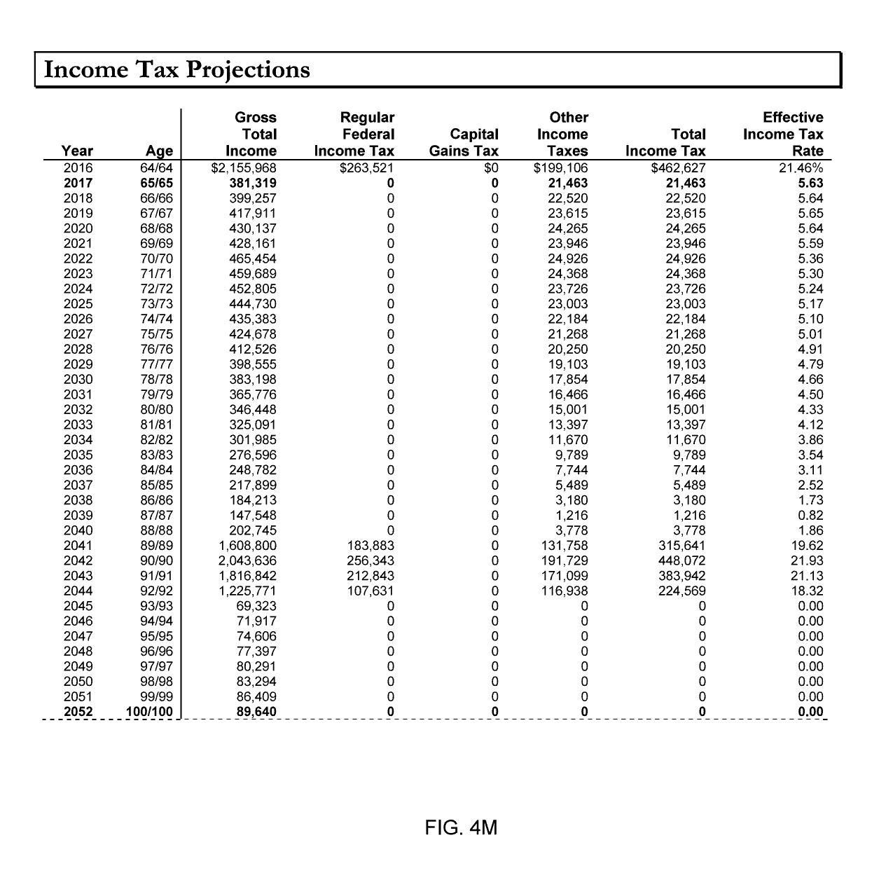

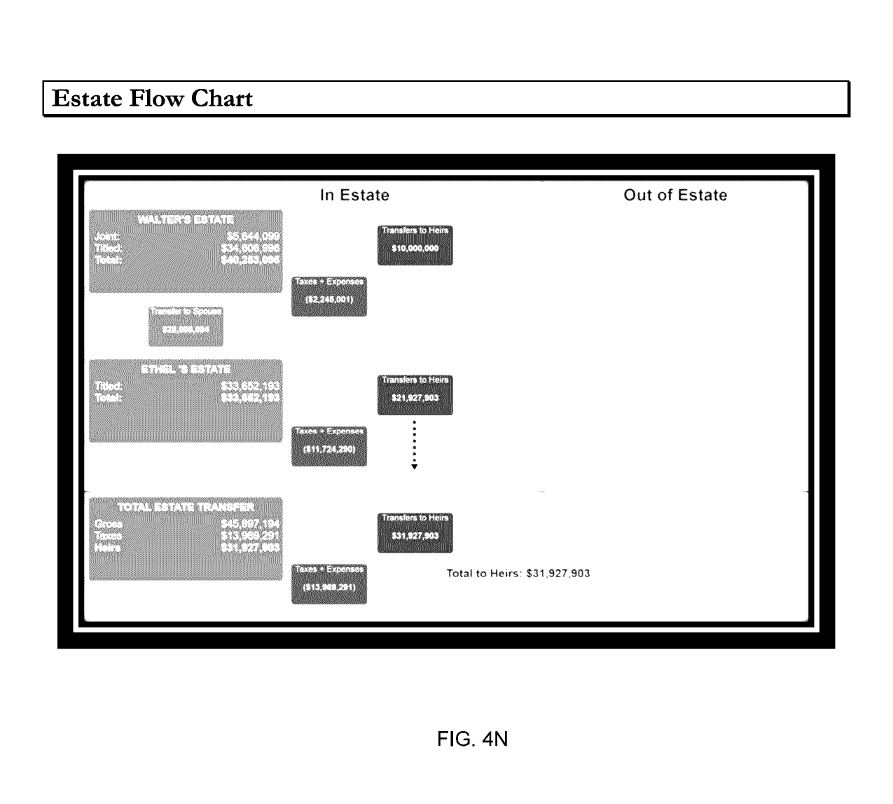

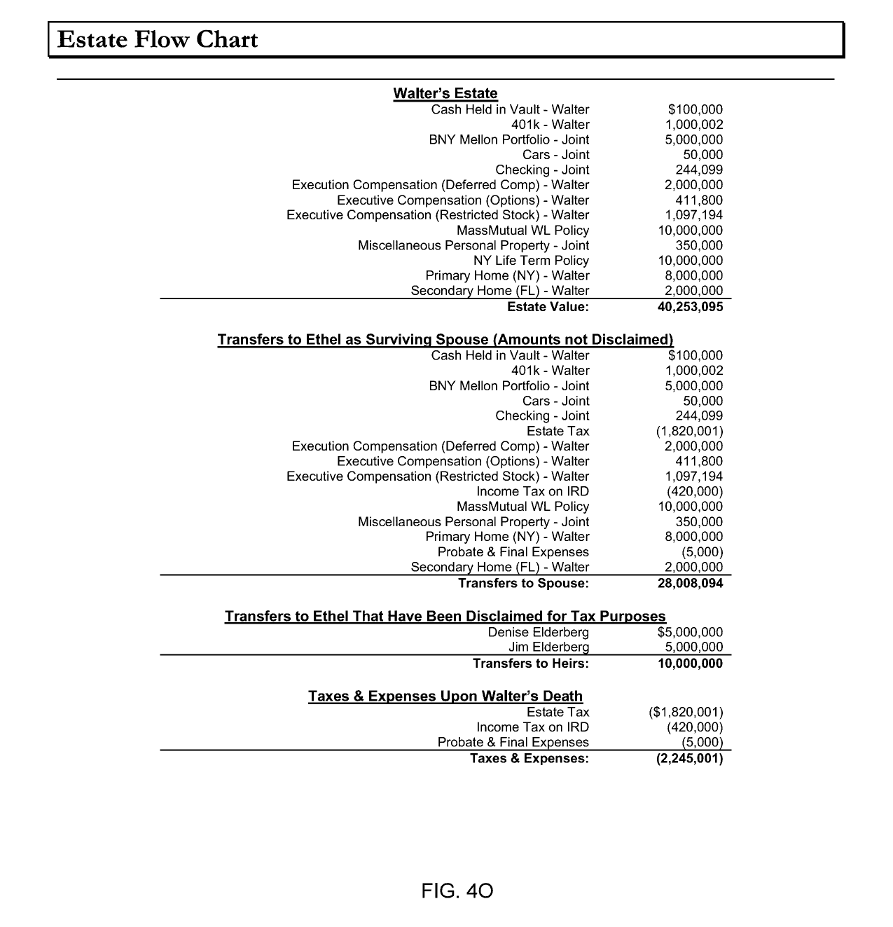

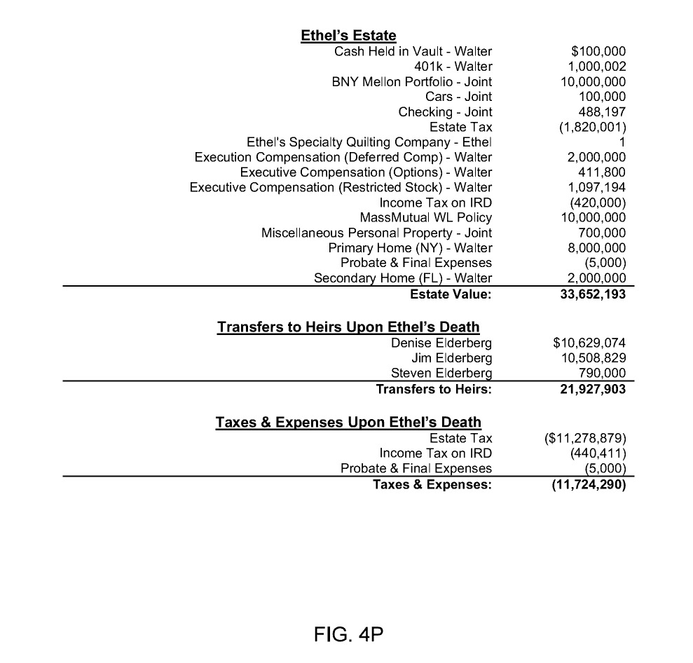

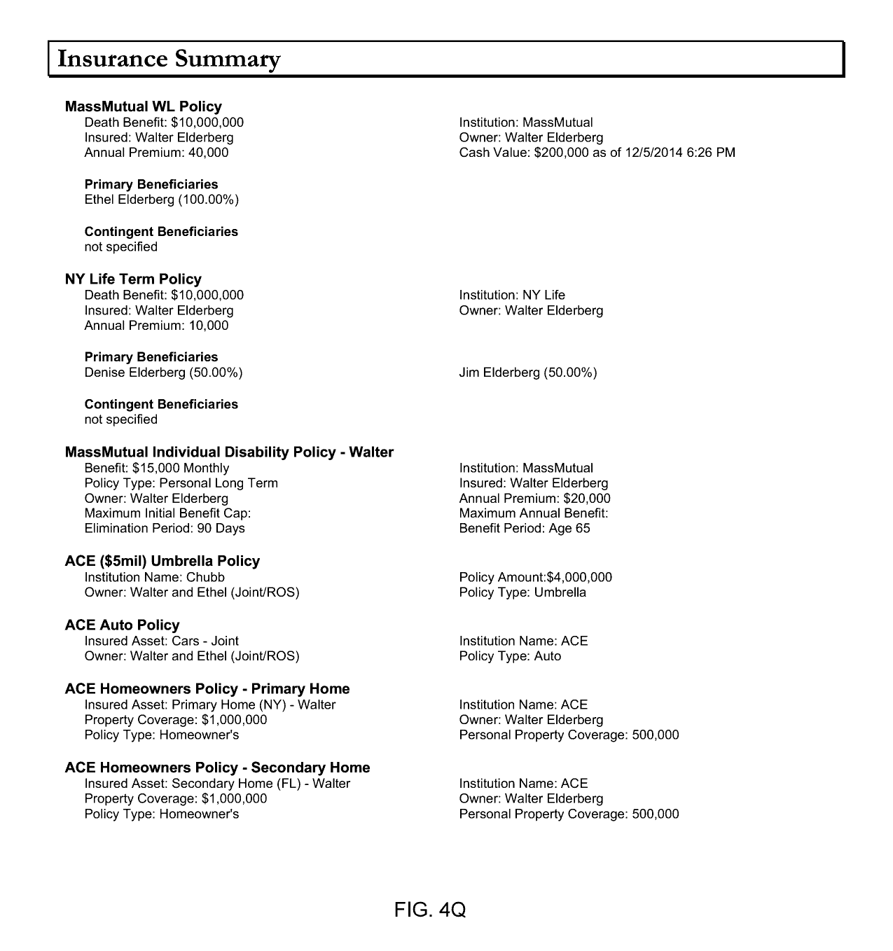

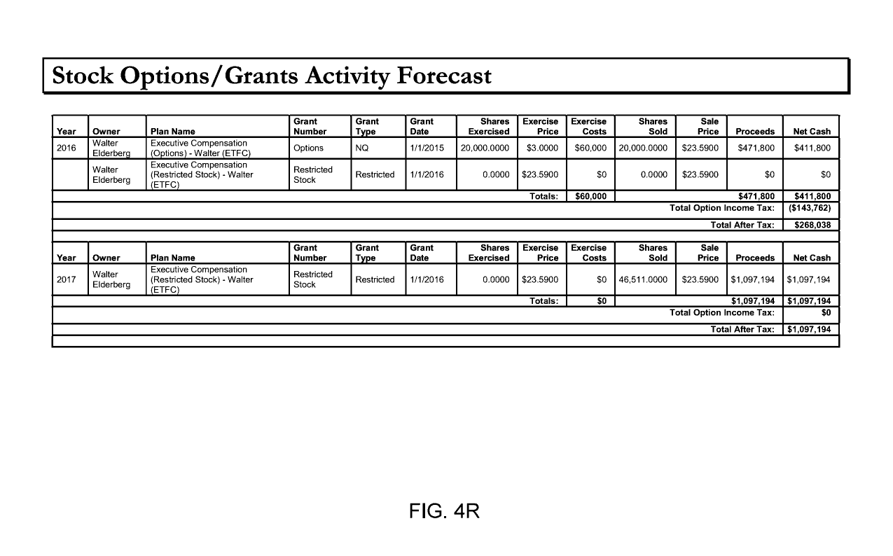

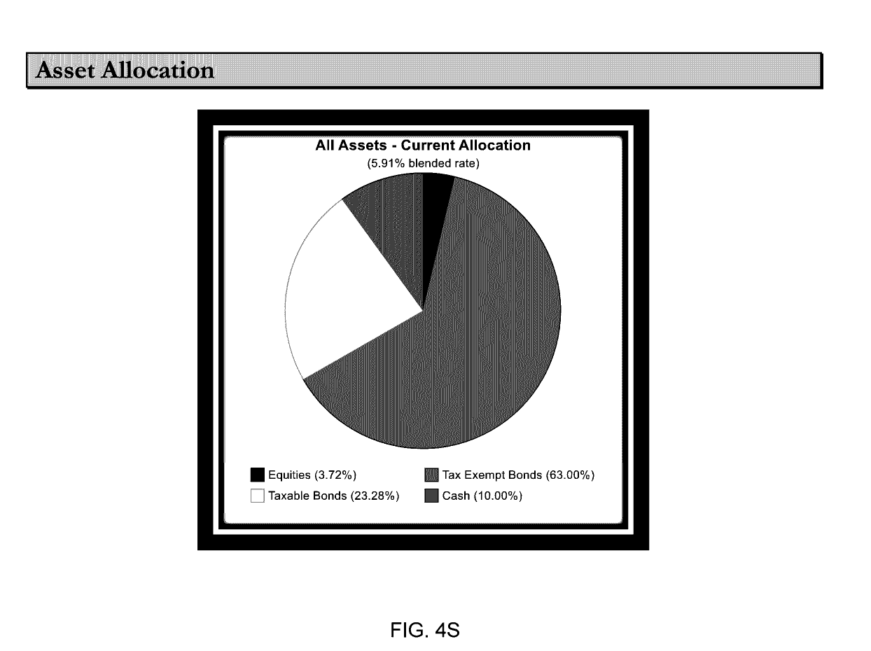

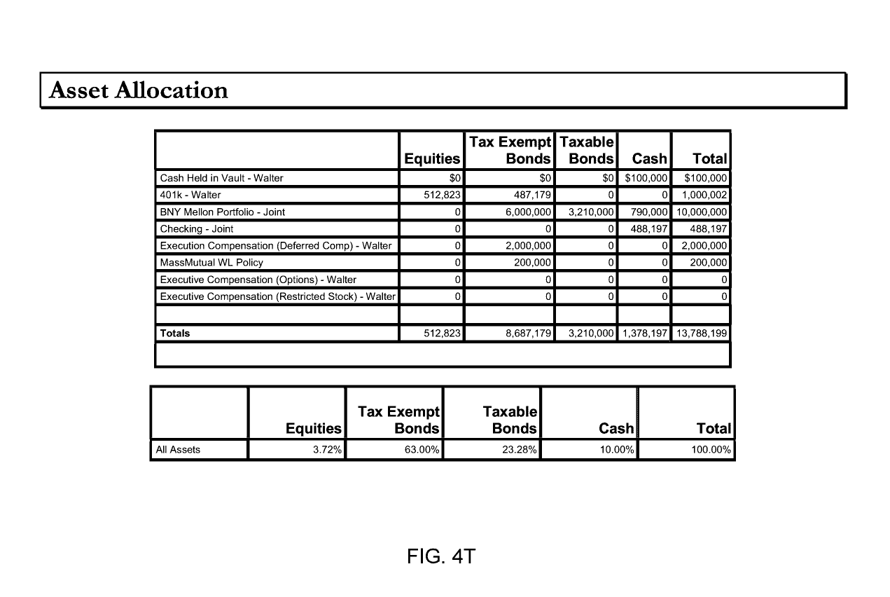

Referring to FIGS. 4A-4T, shown are exemplary screen shots of various financial reports generated by the system of FIG. 1.

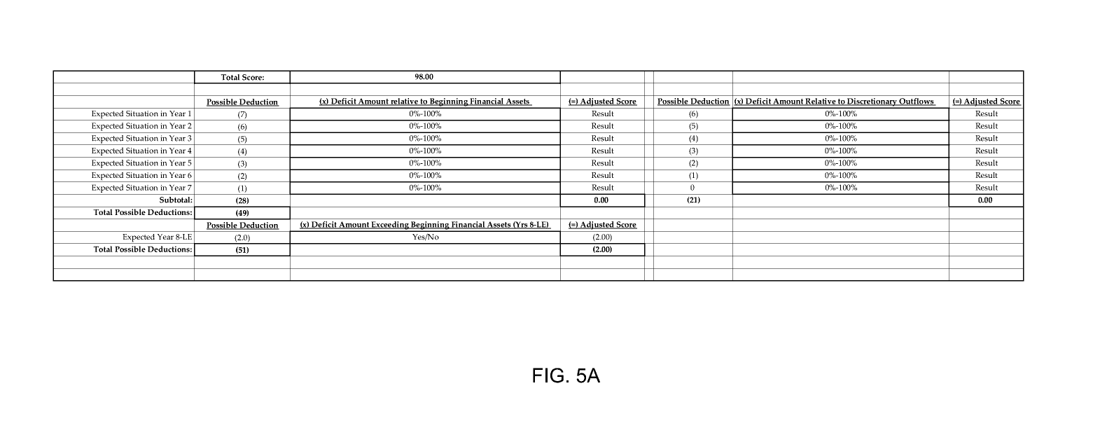

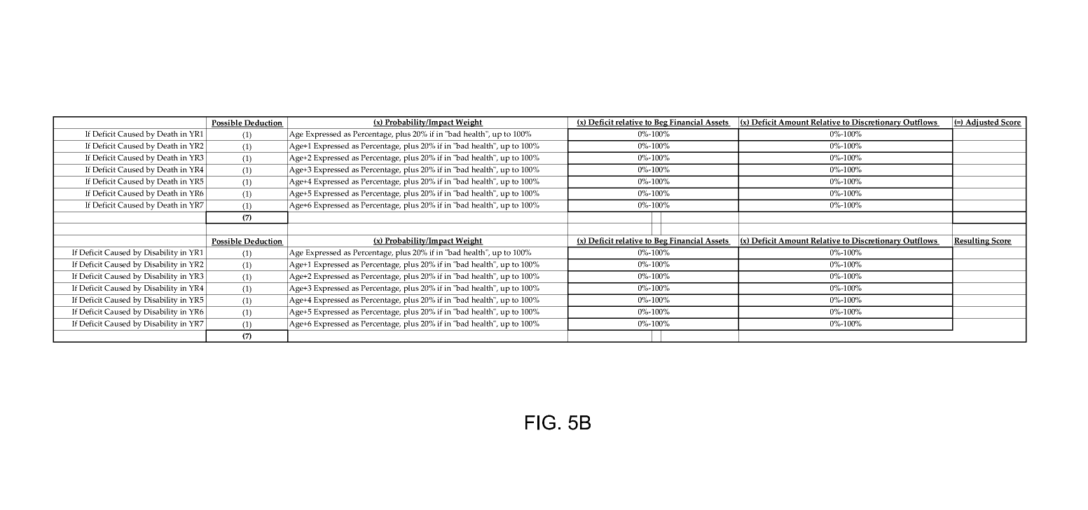

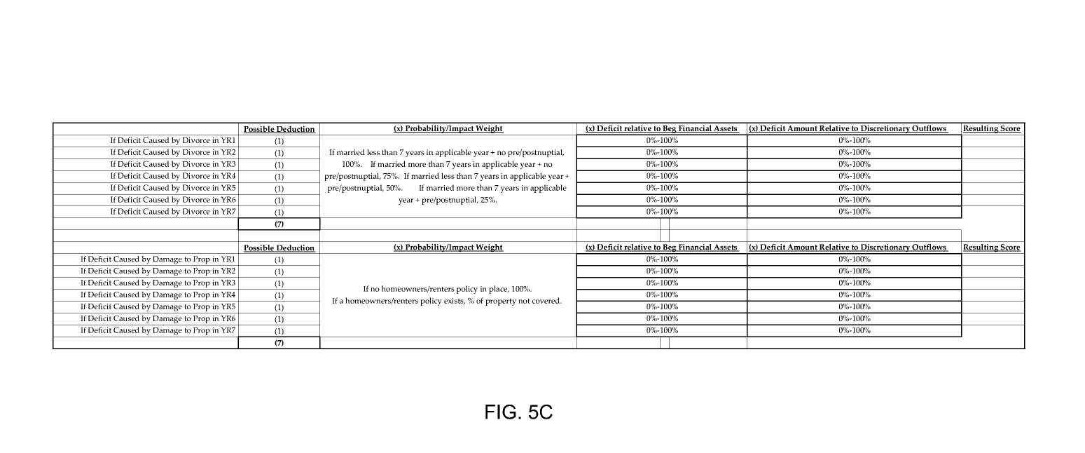

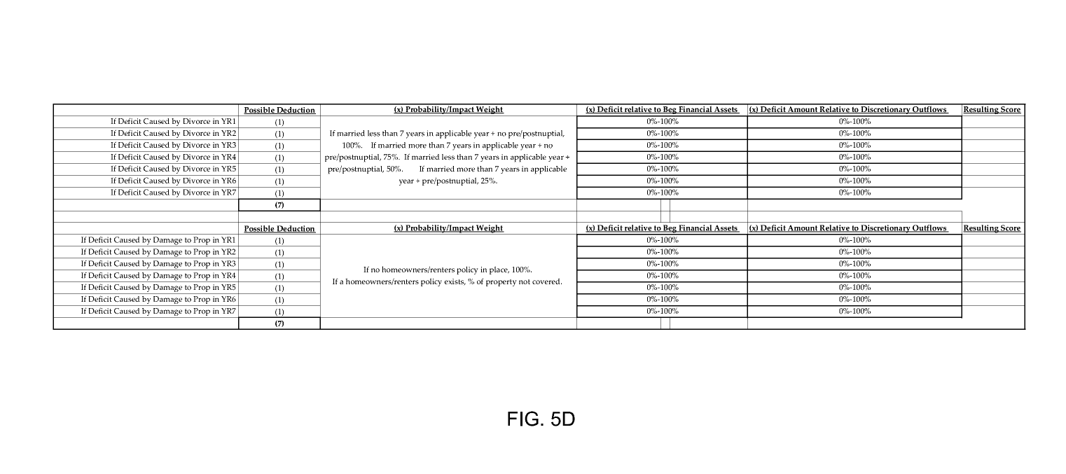

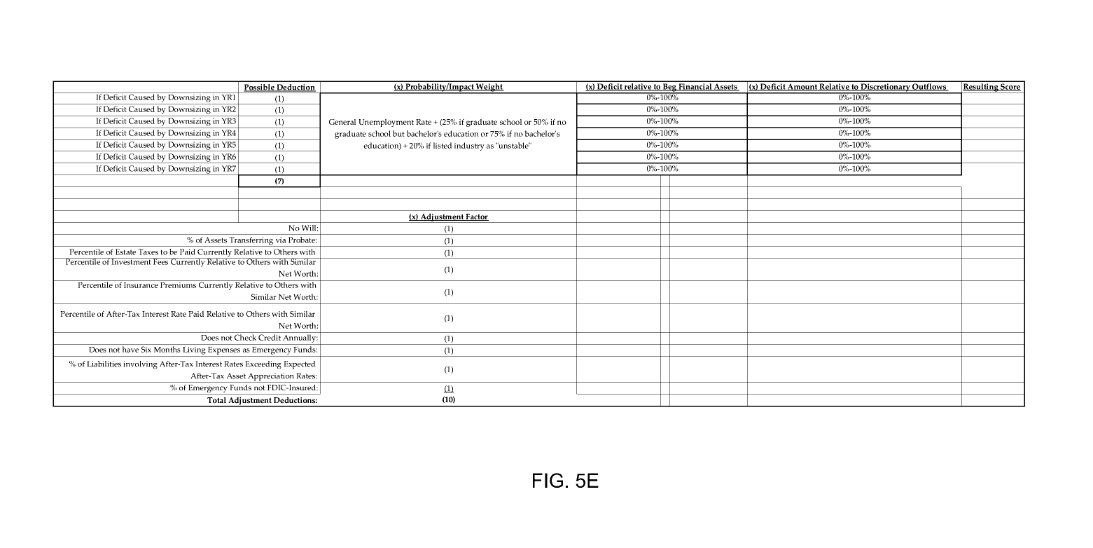

Referring to FIGS. 5A-5E, shown are exemplary screen shots of a comparative scoring formula for the system of FIG. 1.

The present teachings also relate to methodologies for enhancing reliability in the collection and aggregation of private financial data sets for individuals and third-party decision-makers. To date, aggregate data output reports that purport to assist businesses in decision-making related to consumer behavior, demographic trends, product design, pricing and related matters have primarily relied upon data derived directly or indirectly from two sources: (1) private sources (e.g., GOOGLE®, credit bureaus, MarketResearch.com, private surveys, etc.); or (2) government sources (e.g., reports from the U.S. Census Bureau, Internal Revenue Service or data collected through various agencies via FedStats.gov, etc.). Aside from the problem of past behaviors not always being an indication of future expected results, problems exist regarding each such data collection system.

For public data collection, data sets that are knowingly disclosed by an individual to the government have been limited to few data points that the government requires of each individual. In addition, they are often limited by inherent self-interest problems of additional disclosures (such as the disclosure of additional income on tax returns leading to additional taxes) and are based upon that individual's past behaviors and activities (not future expected behaviors and activities). Data sets that are unknowingly disclosed by an individual to the government are based upon metadata retrieved from primarily private sources, and are constitutionally restrained (e.g., privacy regulations) and are similarly limited to past behaviors (which do not always correlate with future results).

For private data collection, data sets that are disclosed by an individual to private sources have been limited to data that must be deduced and gleaned from conversations, behaviors and private activities of that individual, and are similarly based upon past actions or behaviors (not future actions or behaviors). Moreover, private data collection systems depend upon the actions of the individual and have difficulty making reliable conclusions and connections when the individual does not affirmatively act or make other fact or profile disclosures within that private system.

The methodology set forth herein addresses these problems and others. It comprises a private data collection and aggregation methodology that may be based on a web-based system that is superior to those set forth above in at least two critical ways. First, it makes a connection between past behavior and future behavior expected by that individual (not just past behavior). Second, the disclosures that connect future behavior and past behavior can be viewed as more reliable than the ones set forth above for a number of reasons:

1. Direct-source data feeds on past behaviors. Past behaviors and activities may be retrieved directly from the source and do not depend on disclosures by the individual—which reduces potential manipulation or omission by the individual. These third party sources include the financial institutions for which the individual does business.

2. Accuracy-incentivized disclosures from individuals about profile and future expected behaviors. Disclosures made by an individual regarding future expected behaviors and activities are more reliable due to: (i) the inherent anonymity and privacy of the specific disclosures made by the individual into the private system (due to the system only aggregating such information and not disclosing it on an individual level); and (ii) the lack of adverse consequence (in fact, existence of incentive) for the individual to make accurate disclosures regarding future expected behaviors for the benefit of that individual's own use and decision-making. For this same reason, because the accuracy of outputs that assist the individual with decision-making depend heavily on the accuracy of inputs, the individual has an incentive to disclose all information regarding their situation—such as their age, employment status, family members, health, expected retirement age and the extent of all assets, liabilities, income sources and expenses.

In short, the aggregated summary data output reports produced according to the present teachings will be more reliable to third-party decision-makers than traditional data collection sets indicated above due to aligned incentives for truthful disclosures by the individual and the ability to retrieve actual information on future expected behaviors of the individual.

Following is an example detailed step-by-step methodology:

1. Each individual may first input data credentials into data aggregation portal (e.g., website) that may automatically link values, transactional information and category data from bank accounts, credit card and other liabilities accounts, and investment accounts.

2. Each individual may then manually discloses information about personal property, real property, business interests, age, family members, insurance, expected income, expected expenses and debt amounts owed to individuals and data that could not be automatically linked and retrieved from third party financial account aggregation sources.

3. Each individual may then receive output reports and long-term projections based upon #1 and #2 that enable them to make informed future decisions regarding the financial impact of decisions regarding future spending levels, employment, withdrawals from cash and investment accounts, maintaining or paying down debts, social security elections, getting married, getting divorced, having children, estate planning, insurance needs, college funding, investment asset class allocation, and the placement of investments into certain investment vehicles. The individual may retrieve this from a “Base Case” scenario based upon the expectations of each of these variables in the future, and then can see the impact of various specified changes to these variables. The individual may then agree to a “Plan of Action,” with various due dates, and track the implementation of such a plan via notification e-mail alerts.

4. The system may then aggregate output reports and plans of action from individual #1, #2 . . . #1,000+.

5. Businesses and other decision-makers may purchase legitimate aggregate summary output reports (e.g., based on at least 1,000 users) based upon certain relevant criteria.

There also may be control policies. In order to maintain privacy for the individuals who disclose financial information (and to incentivize full, unrestricted disclosures by such individuals), aggregate summary data output reports may be based upon information from at least 1,000 users and may not otherwise make disclosures of data that could reasonably be used to identify the behaviors or actions of any individual within the data set.

In one embodiment, to avoid competitive initiatives between businesses no aggregate summary data output reports may be retrieved using a specific employer of individuals as one of the criteria—except when requested by that specific employer about that specific employer's individual employees in the aggregate where such aggregate data set about such employees exceeds some limit (e.g., 1,000).

In order to control the information upon which reports are created, aggregate summary data output reports may only be based upon user information contained within the system.

In order for the third party decision-maker to understand the entire population of inputs, aggregate summary data output reports may always contain references to metrics applicable to the entire population set (in addition to the sub-filtered criteria set purchased).

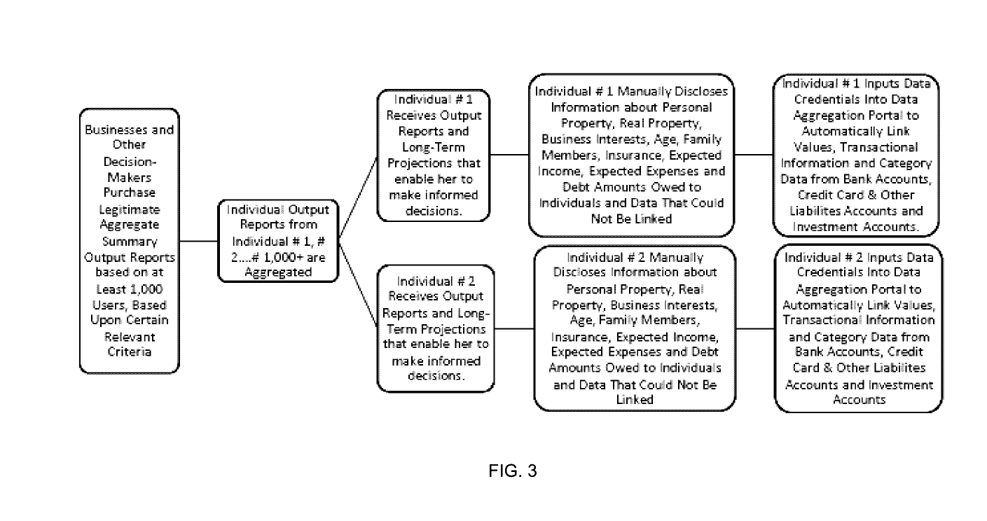

Shown in FIG. 3 is a flow chart for collecting and aggregating financial data according to the present teachings.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A method for gathering, organizing, and analyzing an individual's financial information, comprising:
using a computer to gather financial information from an individual;
generating a balance sheet automatically with the computer using the gathered financial information;
the balance sheet having an asset column and a liability column;
generating a cash flow projections report automatically with the computer using the gathered financial information;
the cash flow projections report having year-by-year projections until a year of expected death for the individual;
calculating a financial score of 0 to 100 with the computer using the gathered financial information, the balance sheet, and the cash flow projections report as follows:
1) analyzing cash flow by starting with 10 points and subtracting 1 point for each 5-year period before the year of expected death where a cash flow projection is negative;
2) analyzing debt management by starting with 10 points and subtracting 1 point for each 5% that debts represent more than 50% of assets;
3) analyzing diversification by starting with 10 points and subtracting 1 point for each 5% that a single asset exceeds 50% of total assets;
4) analyzing estate planning by starting with 10 points and subtracting 2 points if there is insufficient life insurance to replace lost earnings upon a death, subtracting 2 points if individual does not have a will, subtracting 2 points if individual has not instructed another where to find key documents, subtracting 2 points if more than 50% of the individual's estate will pass via probate, and subtracting 2 points if projected estate taxes represent more than 25% of the projected value of the individual's estate;
5) analyzing family planning by: i) starting with 5 points and subtracting 1 point for each year of marriage less than 15 where no prenuptial agreement; and ii) starting with 5 points and subtracting 5 points if getting married or having a child would result in net new outflows at a time when ending cash balances will turn negative in the next ten years;
6) analyzing disability planning by starting with 10 points and subtracting 1 point if no power of attorney, subtracting 1 point if no healthcare directive, subtracting 4 points if no major medical policy, and subtracting 4 points if no long-term disability policy;
7) analyzing property protection by starting with 10 points and subtracting 3 points if no homeowner or renter policy, subtracting 3 points if owning a car and no automobile policy, subtracting 2 points if individual does not have at least 80% of dwelling covered, subtracting 1 point if no riders on special articles of high value, and subtracting 1 point if cash holdings exceed FDIC limits;
8) analyzing legal defense by starting with 10 points and subtracting 5 points if less than 90% of net worth covered by liability insurance, and subtracting 5 points if net worth in excess of a limit for creditor exposures;
9) analyzing down-markets by starting with 10 points and subtracting 1 point for every 10 years that the individual's age exceeds a percentage of overall investments held in non-equities;
10) analyzing demand for business by starting with 10 points and subtracting 3 points for not having a bachelor's degree, subtracting 3 points for not having a master's or professional degree, subtracting 2 points if insufficient barriers to entry, and subtracting 2 points if less than 50% of living expenses in cash accounts.

2. The method of claim 1, wherein the financial score is adjusted by applying a declining 49% of value to the individual's expected financial outcome over the next 7 years, applying a straight 2% to the individual's expected financial outcome for years 8 through a remaining life expectancy, and applying a declining 49% to an unexpected situation over the next 7 years.

3. The method of claim 2 wherein the declining 49% for the unexpected situation is allocated equally among the following 7 events: death, divorce/marriage, disability, property damage, lawsuit, downsizing, down-market.

4. The method of claim 3 wherein 1 point is subtracted for each event in each of the next 7 years for which there is a deficit.

5. The method of claim 2 wherein for the straight 2% 2 points are subtracted if the individual is projected to run out of cash during any year after year 8 through the remaining life expectancy.

6. A system for gathering, organizing, and analyzing an individual's financial information, comprising:
a computer;
a user interface on the computer adapted to gather financial information from the individual;
a balance sheet automatically generated by the computer using the gathered financial information;
the balance sheet having an asset column and a liability column;
a cash flow projections report automatically generated by the computer using the gathered financial information;
the cash flow projections report having year-by-year projections until a year of expected death for the individual;
a financial score of 0 to 100 automatically calculated by the computer using the gathered financial information, the balance sheet, and the cash flow projections report;
the financial score based on the following ten analysis principles, each weighted at 10%:
1) cash flow;
2) debt management;
3) diversification;
4) estate planning;
5) family planning;
6) disability planning;
7) property protection;
8) legal defense;
9) down-markets;
10) demand for business.

7. The system of claim 6 wherein the cash flow projections report is generated by using sources of cash from the gathered financial information, adding cash inflows and subtracting cash outflows from the gathered financial information, applying a portfolio growth rate from the gathered financial information, and applying a rate of inflation.

8. The system of claim 6 wherein the balance sheet is divided into further columns for a married individual, specifying whether each asset is owned separately by one spouse or jointly with rights of survivorship.

9. The system of claim 6 wherein the financial score is calculated using each analysis principle as follows:
1) starting with 10 points, subtract 1 point for each 5-year period before the year of expected death where a cash flow projection is negative;
2) starting with 10 points, subtract 1 point for each 5% that debts represent more than 50% of assets;
3) starting with 10 points, subtract 1 point for each 5% that a single asset exceeds 50% of total assets;
4) starting with 10 points,
i) subtract 2 points if there is insufficient life insurance to replace lost earnings upon a death;
ii) subtract 2 points if individual does not have a will;
iii) subtract 2 points if individual has not instructed another where to find key documents;
iv) subtract 2 points if more than 50% of the individual's estate will pass via probate;
v) subtract 2 points if projected estate taxes represent more than 25% of the projected value of the individual's estate;
5)
i) starting with 5 points, subtract 1 point for each year of marriage less than 15 where no prenuptial agreement;
ii) starting with 5 points, subtract 5 points if getting married or having a child would result in net new outflows at a time when ending cash balances will turn negative in the next ten years;
6) starting with 10 points, subtract 1 point if no power of attorney, subtract 1 point if no healthcare directive, subtract 4 points if no major medical policy, and subtract 4 points if no long-term disability policy;
7) starting with 10 points, subtract 3 points if no homeowner or renter policy, subtract 3 points if owning a car and no automobile policy, subtract 2 points if individual does not have at least 80% of dwelling covered, subtract 1 point if no riders on special articles of high value, and subtract 1 point if cash holdings exceed FDIC limits;
8) starting with 10 points, subtract 5 points if less than 90% of net worth covered by liability insurance, and subtract 5 points if net worth in excess of a limit for creditor exposures;
9) starting with 10 points, subtract 1 point for every 10 years that the individual's age exceeds a percentage of overall investments held in non-equities;
10) starting with 10 points, subtract 3 points for not having a bachelor's degree, subtract 3 points for not having a master's or professional degree, subtract 2 points if insufficient barriers to entry, and subtract 2 points if less than 50% of living expenses in cash accounts.

10. The system of claim 9 wherein the year of expected death is 100.

11. The system of claim 9 wherein the limit for creditor exposures is $50 million.

12. The system of claim 9 wherein the key documents comprise account statements, insurance policies, tax returns, and estate planning documents.

13. The system of claim 9 wherein the barriers to entry comprise intellectual property, capital intensity, or another barrier as assessed by the individual.

14. The system of claim 6 wherein the computer transmits the balance sheet and cash flow projections report to the individual.

15. The system of claim 6 further comprising an interface to link accounts of the individual at third-party financial institutions so that the system can automatically download transaction data for those accounts.

16. The system of claim 6 wherein the individual can upload financial-related documents for storage in the system.

17. The system of claim 6 wherein the computer comprises a plurality of computers communicating with each other over a network.

18. The system of claim 6 wherein the user interface on the computer comprises a webpage.

19. The system of claim 18 wherein there is a webpage for gathering each category of facts from the individual.

20. A system for gathering, organizing, and analyzing an individual's financial information, comprising:
a computer;
a user interface on the computer adapted to gather financial information from the individual;
a balance sheet automatically generated by the computer using the gathered financial information;
the balance sheet having an asset column and a liability column;
a cash flow projections report automatically generated by the computer using the gathered financial information;
the cash flow projections report having year-by-year projections until a year of expected death for the individual;
a financial score of 0 to 100 calculated by the computer using the gathered financial information, the balance sheet, and the cash flow projections report;
the financial score based on ten analysis principles, each weighted at 10%.
